(19) United States
(12) Patent Application Publication
(10) Pub. No.: US 2025/0063416 A1
(43) Pub. Date: Feb. 20, 2025

(54) METHOD AND APPARATUS FOR USING MEASUREMENT GAP OF UE HAVING WAKE-UP RECEIVER IN COMMUNICATION SYSTEM

(71) Applicant: Samsung Electronics Co., Ltd., Suwon-si (KR)

(72) Inventors: Seunghoon CHOI, Suwon-si (KR); Hyewon YANG, Suwon-si (KR); Jaewon LEE, Suwon-si (KR)

(21) Appl. No.: 18/805,949

(22) Filed: Aug. 15, 2024

(30) Foreign Application Priority Data
Aug. 16, 2023 (KR) 10-2023-0107084

(51) Int. Cl. H04W 24/10; H04W 52/02

(52) U.S. Cl. CPC H04W 24/10; H04W 52/0229

(57) ABSTRACT

The disclosure relates to a 5^{th} generation (5G) or a 6^{th} generation (6G) communication system for supporting a higher data transmission rate. A method and performed by a user equipment (UE) in a communication system is provided. The method includes receiving, via higher layer signaling, a first configuration of measurement gap and a second configuration associated with whether signal transmission that is available to be received by the UE using a wake-up receiver (WUR) of the UE is supported by a plurality of cells, identifying the measurement gap based on the first configuration, identifying at least one cell supporting the signal transmission among the plurality of cells based on the second configuration, and performing, by using the WUR during the measurement gap, a measurement for the at least one cell.

### CROSS-REFERENCE TO RELATED APPLICATION(S)

This application is based on and claims priority under 35 U.S.C. § 119 (a) of a Korean patent application number 10-2023-0107084, filed on Aug. 16, 2023, in the Korean Intellectual Property Office, the disclosure of which is incorporated by reference herein in its entirety.

### BACKGROUND

### 1. Field

The disclosure relates to a wireless communication system. More particularly, the disclosure relates to a method and an apparatus for allowing a terminal having a wake-up receiver performs radio resource measurement (RRM) through the wake-up receiver in a measurement gap (MG) and a main radio transmits and receives data at the same time in a wireless communication system.

More particularly, the disclosure relates to a method and an apparatus for allowing the terminal having the wake-up receiver to perform cell signal quality measurement through the wake-up receiver and the main radio seamlessly transmits and receives data to and from a base station (BS) in order to solve an excessive power consumption problem of the terminal and achieve high energy efficiency in a wireless communication system.

### 2. Description of Related Art

5^{th} generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz bands (e.g., 95 GHz to 3 terahertz (THz) bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As described above, with the development of the wireless communication system, a method of transmitting a signal by the terminal having the wake-up receiver is needed to solve the excessive power consumption problem of the terminal and achieve high energy efficiency.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, as aspect of the disclosure is to provide a method and an apparatus for measuring radio resource measurement (RRM) by a terminal having a wake-up receiver in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes receiving, via higher layer signaling, a first configuration of measurement gap and a second configuration associated with whether signal transmission that is available to be received by the UE using a wake-up receiver (WUR) of the UE is supported by a plurality of cells, identifying the measurement gap based on the first configuration, identifying at least one cell supporting the signal transmission among the plurality of cells based on the second configuration, and performing, by using the WUR during the measurement gap, a measurement for the at least one cell.

According to an embodiment of the disclosure, the signal transmission includes at least one of on-off keying (OOK)-based signal transmission or orthogonal frequency division multiplexing (OFDM)-based signal transmission.

According to an embodiment of the disclosure, the plurality of cells includes at least one of a neighbor cell, a cell on a particular frequency band, or a cell on a particular frequency.

According to an embodiment of the disclosure, the OOK-based signal transmission includes at least one of OOK-based wake-up signal transmission or OOK-based synchronization signal transmission.

According to an embodiment of the disclosure, the OFDM-based signal transmission includes at least one of primary synchronization signal (PSS) transmission, secondary synchronization signal (SSS) transmission, physical broadcast channel (PBCH) transmission, or synchronization signal block (SSB) transmission.

According to an embodiment of the disclosure, the method further includes communicating, by using a main radio (MR) of the UE during the measurement gap, at least one of a downlink signal or an uplink signal with a serving cell different from the plurality of cells, wherein the downlink signal does not include a wake-up signal.

According to an embodiment of the disclosure, the method further includes receiving, via the higher layer signaling, a third configuration of a first transmission resource for a measurement report for the measurement performed by using the WUR, and transmitting the measurement report for the measurement performed by using the WUR on the first transmission resource.

According to an embodiment of the disclosure, the measurement report is transmitted by using a MR of the UE.

According to an embodiment of the disclosure, the first transmission resource is configured separately from a second transmission resource for a measurement report for a measurement performed by using the MR, or the second transmission resource is shared with the first transmission resource.

In accordance with another aspect of the disclosure, a user equipment (UE) in a communication system is provided. The UE includes a transceiver, and a processor coupled with the transceiver and configured to receive, via higher layer signaling, a first configuration of measurement gap and a second configuration associated with whether signal transmission that is available to be received by the UE using a wake-up receiver (WUR) of the UE is supported by a plurality of cells, identify the measurement gap based on the first configuration, identify at least one cell supporting the signal transmission among the plurality of cells based on the second configuration, and perform, by using the WUR during the measurement gap, a measurement for the at least one cell.

According to an embodiment of the disclosure, the signal transmission includes at least one of on-off keying (OOK)-based signal transmission or orthogonal frequency division multiplexing (OFDM)-based signal transmission.

According to an embodiment of the disclosure, the plurality of cells includes at least one of a neighbor cell, a cell on a particular frequency band, or a cell on a particular frequency.

According to an embodiment of the disclosure, the OOK-based signal transmission includes at least one of OOK-based wake-up signal transmission or OOK-based synchronization signal transmission.

According to an embodiment of the disclosure, the OFDM-based signal transmission includes at least one of primary synchronization signal (PSS) transmission, secondary synchronization signal (SSS) transmission, physical broadcast channel (PBCH) transmission, or synchronization signal block (SSB) transmission.

According to an embodiment of the disclosure, the processor is further configured to communicate, by using a main radio (MR) of the UE during the measurement gap, at least one of a downlink signal or an uplink signal with a serving cell different from the plurality of cells, wherein the downlink signal does not include a wake-up signal.

According to an embodiment of the disclosure, the processor is further configured to receive, via the higher layer signaling, a third configuration of a first transmission resource for a measurement report for the measurement performed by using the WUR, and transmit the measurement report for the measurement performed by using the WUR on the first transmission resource.

According to an embodiment of the disclosure, the measurement report is transmitted by using a MR of the UE, and wherein the first transmission resource is configured separately from a second transmission resource for a measurement report for a measurement performed by using the MR, or wherein the second transmission resource is shared with the first transmission resource.

In accordance with another aspect of the disclosure, a method performed by a base station in a communication system is provided. The method includes transmitting, to a user equipment (UE) via higher layer signaling, a first configuration of measurement gap and a second configuration associated with whether signal transmission that is available to be received by the UE using a wake-up receiver (WUR) of the UE is supported by a plurality of cells, and receiving a measurement report for a measurement for at least one cell supporting the signal transmission among the plurality of cells, wherein the measurement is associated with the WUR and the measurement gap.

According to an embodiment of the disclosure, the signal transmission includes at least one of on-off keying (OOK)-based signal transmission or orthogonal frequency division multiplexing (OFDM)-based signal transmission.

According to an embodiment of the disclosure, the plurality of cells includes at least one of a neighbor cell, a cell on a particular frequency band, or a cell on a particular frequency.

According to an embodiment of the disclosure, the OOK-based signal transmission includes at least one of OOK-based wake-up signal transmission or OOK-based synchronization signal transmission.

According to an embodiment of the disclosure, the OFDM-based signal transmission includes at least one of primary synchronization signal (PSS) transmission, secondary synchronization signal (SSS) transmission, physical broadcast channel (PBCH) transmission, or synchronization signal block (SSB) transmission.

According to an embodiment of the disclosure, the method further includes transmitting, via the higher layer signaling, a third configuration of a first transmission resource for the measurement report.

According to an embodiment of the disclosure, the measurement report is received on the first transmission resource.

According to an embodiment of the disclosure, the first transmission resource is configured separately from a second transmission resource for a measurement report for a measurement associated with a main radio of the UE, or wherein the second transmission resource is shared with the first transmission resource.

In accordance with another aspect of the disclosure, a base station in a communication system is provided. The base station includes a transceiver, and a processor coupled with the transceiver and configured to transmit, to a user equipment (UE) via higher layer signaling, a first configuration of measurement gap and a second configuration associated with whether signal transmission that is available to be received by the UE using a wake-up receiver (WUR) of the UE is supported by a plurality of cells, and receive a measurement report for a measurement for at least one cell supporting the signal transmission among the plurality of cells, wherein the measurement is associated with the WUR and the measurement gap.

According to an embodiment of the disclosure, the signal transmission includes at least one of on-off keying (OOK)-based signal transmission or orthogonal frequency division multiplexing (OFDM)-based signal transmission.

According to an embodiment of the disclosure, the plurality of cells includes at least one of a neighbor cell, a cell on a particular frequency band, or a cell on a particular frequency.

According to an embodiment of the disclosure, the OOK-based signal transmission includes at least one of OOK-based wake-up signal transmission or OOK-based synchronization signal transmission.

According to an embodiment of the disclosure, the OFDM-based signal transmission includes at least one of primary synchronization signal (PSS) transmission, secondary synchronization signal (SSS) transmission, physical broadcast channel (PBCH) transmission, or synchronization signal block (SSB) transmission.

According to an embodiment of the disclosure, the processor is further configured to transmit, via the higher layer signaling, a third configuration of a first transmission resource for the measurement report.

According to an embodiment of the disclosure, the measurement report is received on the first transmission resource.

According to an embodiment of the disclosure, the first transmission resource is configured separately from a second transmission resource for a measurement report for a measurement associated with a main radio of the UE, or wherein the second transmission resource is shared with the first transmission resource.

The disclosure provides an apparatus and a method for effectively providing a service in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of time-frequency resource domains in a wireless communication system according to an embodiment of the disclosure;

FIG. 2 illustrates a time domain mapping structure of a synchronization signal and a beam sweeping operation according to an embodiment of the disclosure;

FIG. 3 illustrates a flow of signals for random access (RA) according to an embodiment of the disclosure;

FIG. 4 illustrates a flow of signals for a report on UE capability information to a BS by a UE according to an embodiment of the disclosure;

FIG. 5 illustrates state switching of a BS and a UE and an example of states of the UE depending on a BS state according to an embodiment of the disclosure;

FIG. 6 is a flowchart illustrating an operation of a UE including a wake-up receiver according to an embodiment of the disclosure;

FIG. 7 is a flowchart illustrating an operation of a BS according to an embodiment of the disclosure;

FIG. 8 illustrates a structure of a UE according to an embodiment of the disclosure; and

FIG. 9 illustrates a structure of a BS according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing embodiments of the disclosure, in case that it is determined that a detailed description of technology that has been already known in the art to which the disclosure belongs and is directly irrelevant to the disclosure will be omitted. This is to omit the unnecessary description and more clearly convey the gist of the disclosure without obscuring the gist of the disclosure.

For the same reason, in the accompanying drawings, some components may be exaggerated, omitted, or schematically illustrated. Further, the size of each component does not completely reflect the actual size. In the drawings, the same or corresponding components are provided with the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals refer to the same or like elements.

Herein, it will be understood that each block of the flowchart illustrations, and combinations of blocks in the flowchart illustrations, can be implemented by computer program instructions. Because these computer program instructions may be embedded in a processor of a general-purpose computer, a special-purpose computer, or other programmable data processing apparatuses, the instructions executed through the processor of the computer or other programmable data processing apparatus generates means for performing the functions described in the flowchart block(s). Because these computer program instructions may also be stored in a computer usable or computer-readable memory that may direct the computer or other programmable data processing apparatus so as to implement functions in a particular manner, the instructions stored in the computer usable or computer-readable memory are also capable of producing an article of manufacture containing instruction modules for performing the functions described in the flowchart block(s). Because the computer program instructions may also be embedded into the computer or other programmable data processing apparatus, the instructions for executing the computer or other programmable data processing apparatuses by generating a computer-implemented process by performing a series of operations on the computer or other programmable data processing apparatuses may provide operations for executing the functions described in the flowchart block(s).

Further, each block of the flowchart illustrations may represent a module, segment, or portion of code, which includes one or more executable instructions to execute the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the corresponding functionality involved.

As used herein, the term “˜unit” refers to a software or a hardware component, such as a field programmable gate array (FPGA) or an application specific integrated circuit (ASIC), which plays any role. However, the “˜unit” does not always have a meaning limited to software or hardware. The “unit” may be constructed either to be stored in an addressable storage medium or to execute one or more processors. Therefore, the “˜unit” includes, for example, components, such as software components, object-oriented software components, class components, and task components, processes, functions, attributes, procedures, subroutines, segments of program code, drivers, firmware, microcode, circuit, data, databases, data structures, tables, arrays, and variables. The function provided in the components and “˜units” may be combined into fewer components and “˜units” or may be further separated into additional components and “˜units”. Further, the components and “˜units” may be implemented to operate one or more central processing units (CPUs) in a device or a secure multimedia card. In addition, the “˜unit” may include one or more processors in embodiments.

In the following description of the disclosure, a detailed description of known functions or constitutions incorporated herein will be omitted when it may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various pieces of identification information, and the like are illustratively used for the sake of convenience. Therefore, the disclosure is not limited by the terms as used below, and other terms referring to subjects having the equivalent technical meanings may be used.

In the following description, a physical channel and a signal may be interchangeably used with data or a control signal. For example, a physical downlink shared channel (PDSCH) is the term referring to a physical channel for transmitting data, but is used to refer to data. That is, in the disclosure, the expression “transmits a physical channel” may be construed to be the same as the expression “transmits data or a signal through a physical channel”.

In the following description, higher-layer signaling is a signal transmission method through which a base station transmits a signal to a user equipment (UE) by using a downlink data channel of a physical layer or a UE transmits a signal to a base station by using an uplink data channel of a physical layer. Higher-layer signaling may be understood as radio resource control (RRC) signaling or a media access control (MAC) control element (CE).

Further, the disclosure describes various embodiments on the basis of the terms used in some communication standards (e.g., 3^{rd} generation partnership project (3GPP)), but they are only examples. Various embodiments of the disclosure may be easily modified and applied to other communication systems. The term “UE” may indicate not only a mobile phone, a smartphone, an IoT device, or a sensor but also other wireless communication devices.

Hereinafter, a base station is an entity that allocates resources to UEs, and may be at least one of a gNode B, a gNB, an eNode B, an eNB, a Node B, a base station (BS), a wireless access unit, a base station controller, or a node on a network. A terminal may include a user equipment (UE), a mobile station (MS), a cellular phone, a smartphone, a computer, or a multimedia system capable of performing communication functions. Of course, the disclosure is not limited to the examples. In addition, various embodiments of the disclosure will be described below using a system based on LTE, LTE-A, or NR as an example, but the various embodiments of the disclosure can also be applied to other communication systems with similar technical background or channel type. Further, an embodiment may be modified in such a range as not to significantly depart from the scope of the disclosure under the determination by one of ordinary skill in the art and such modifications may be applicable to other communication systems.

In order to process mobile data traffic that recently explosively increases, the initial standard of 5^{th} generation (5G) system or new radio technology (NR) which is a next-generation communication system after long-term evolution (LTE or evolved universal terrestrial radio access (E-UTRA)) and LTE-advanced (LTE-A or E-UTRA evolution) has been completed. While the conventional mobile communication system focused on general voice/data communication, the 5G system aims at meeting various services and requirements, such as enhanced mobile broadband (eMBB) service, ultra-reliable and low latency communication (URLLC) service, massive machine type communication (MTC) service supporting massive object communication to improve the conventional voice/data communication.

A system transmission bandwidth per carrier is limited to a maximum of 20 MHz in conventional LTE and LTE-A, but the main goal of the 5G system is to provide high-speed data service that reaches several Gbps by using a much wide ultra-wide bandwidth. Accordingly, the 5G system considers ultra-higher frequency bands from several GHz to a maximum of 100 GHz in which ultra-wide bandwidth frequencies can be relatively easily secured as candidate frequencies. In addition, it is possible to secure wide bandwidth frequencies for the 5G system through frequency re-arrangement or allocation among frequency bands from hundreds of MHz to several GHz used in the conventional mobile communication system.

Propagation in the ultra-higher frequency band has a wavelength of several mm, which is called a millimeter wave (mmWave). However, in the ultra-high frequency band, a pathloss of propagation increases in proportion to a frequency band, and thus the coverage of the mobile communication system decreases.

In order to overcome disadvantages of the coverage decrease in the ultra-high frequency band, a beamforming technology that increases an arrival distance of propagation by concentrating propagation radiation energy to a predetermined destination point through a plurality of antennas is applied. That is, for a signal to which the beamforming technology is applied, a beamwidth of the signal becomes relatively narrower, and radiation energy is concentrated in the narrowed beamwidth and thus the arrival distance of propagation increases. The beamforming technology may be applied to each of a transmitting side and a receiving side. The beamforming technology has an effect of reducing interference in areas other than a beamforming direction as well as a coverage increase effect. A method of accurately measuring and feeding back transmission/reception beams is required to properly operate the beamforming technology. The beamforming technology may be applied to a control channel or a data channel between a predetermined UE and a base station in one-to-one correspondence. Further, the beamforming technology may be applied to increase the coverage for control channels and data channels for transmitting common signals which the base station transmits to a plurality of UEs in the system, for example, synchronization signals, broadcast channels (physical broad channels (PBCHs)), and system information. When the beamforming technology is applied to a common signal, a beam sweeping technology that changes a beam direction and transmits signals may be additionally applied, so as to allow common signals to reach UEs existing in predetermined locations within the cell.

As other requirements of the 5G system, ultra-low latency service having 1 ms or so of a transmission delay between transmitting and receiving sides is needed. One scheme to reduce the transmission delay needs to design a frame structure based on a short transmission time interval (TTI) that is shorter than LTE and LTE-A. The TTI is a basic time unit for performing scheduling, and the TTI in the conventional LTE and LTE-A systems and is 1 ms corresponding to the length of one subframe. For example, short TTIs to meet requirements of the ultra-low latency service of the 5G system includes 0.5 ms, 0.25 ms, 0.125 ms, and the like that are shorter than the conventional LTE and LTE-A systems.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

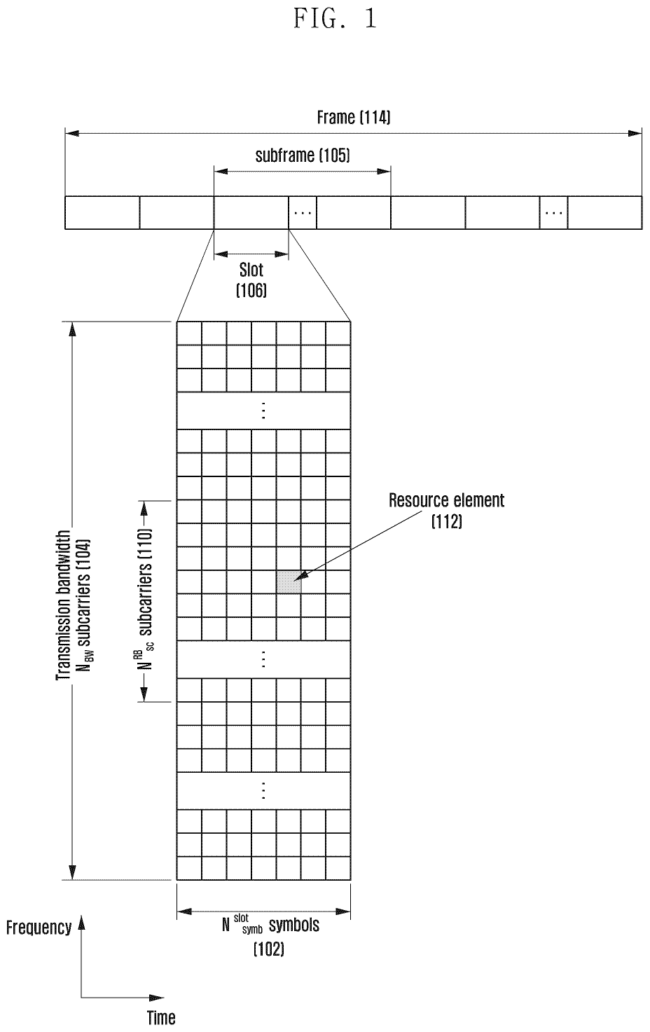

FIG. 1 illustrates a basic structure of time-frequency resource domains in a wireless communication system according to an embodiment of the disclosure.

FIG. 1 illustrates the basic structure of time-frequency resource domains that are radio resource areas in which data or control channels of a 5G system are transmitted.

Referring to FIG. 1, a horizontal axis indicates a time domain and a vertical axis indicates a frequency domain in FIG. 1. A minimum transmission unit in the time domain of the wireless communication system is an orthogonal frequency division multiplexing (OFDM) symbol, N_{symb}^{slot} symbols 102 constitute one slot 106, and Nₛₗₒₜ^{subframe} slots constitute one subframe 105. The length of the subframe is 1.0 ms, and 10 subframes may constitute a frame 114 of 10 ms. A minimum transmission unit in the frequency domain is a subcarrier, and the bandwidth of an entire system transmission band (transmission bandwidth) may be constituted by a total of NBW subcarriers 104.

A basic unit of resources in the time-frequency domains is a resource element (RE) 112 and may be indicated by an OFDM symbol index and a subcarrier index. A resource block (RB or physical resource block (PRB)) may be defined as N_{sc}^{RB} consecutive subcarriers 110 in the frequency domain. In the 5G system, N_{sc}^{RB}=12, and a data rate may increase in proportion to the number of RBs scheduled in the UE.

In the wireless communication system, the BS may map data in units of RBs and generally schedule RBs that constitute one slot for a predetermined UE. That is, a basic time unit in which scheduling is performed in the 5G system may be a slot, and a basic frequency unit in which scheduling is performed may be an RB.

The number N_{symb}^{slot} of OFDM symbols is determined according to the length of a cyclic prefix (CP) added to every symbol to prevent interference between symbols and, for example, N_{symb}^{slot}=14 when a normal CP is applied, and N_{symb}^{slot}=12 when an extended CP is applied. Compared to the normal CP, the extended CP may be applied to a system having a relatively longer propagation transmission distance, thereby maintaining orthogonality between symbols. In the case of the normal CP, a ratio between the CP length and the symbol length is maintained as a predetermined value, and thus overhead due to the CP may be constantly maintained regardless of subcarrier spacing. That is, when the subcarrier spacing is small, the symbol length becomes longer, and accordingly the CP length may also become longer. Contrary to this, when the subcarrier spacing is larger, the symbol length becomes shorter, and accordingly the CP length may become shorter. The symbol length and the CP length may be inversely proportional to the subcarrier spacing.

In order to meet various services and requirements, various frame structures may be supported through the control of subcarrier spacing in the wireless communication system. For example, in a viewpoint of an operation frequency band, it is advantageous to reconstruct phase noise of a high-frequency band as subcarrier spacing is large. In a viewpoint of a transmission time, when subcarrier spacing is large, the symbol length in the time domain becomes shorter, and as a result, the slot length becomes shorter, and thus it is advantageous to support an ultra-low latency service like URLLC. In a viewpoint of a cell size, a larger cell can be supported as the CP length is longer, and thus a relatively larger cell may be supported as subcarrier spacing is smaller. A cell is a concept indicating an area managed by one BS in mobile communication.

The subcarrier spacing, the CP length, and the like are information necessary for OFDM transmission and reception, and smooth transmission and reception are possible only when the BS and the UE recognize the subcarrier spacing, the CP length, and the like as common values.

Table 1 below shows the relationship between a subcarrier spacing configuration (μ), subcarrier spacing (Δf), and the CP length, supported by the 5G system.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below shows the number N_{symb}^{slot} of symbols per slot, the number Nₛₗₒₜ^{frame,μ} of slots per frame, and the number Nₛₗₒₜ^{subframe,μ} of slots per subframe in each subcarrier spacing configuration u in the case of the normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below shows the number N_{symb}^{slot} of symbols per slot, the number Nₛₗₒₜ^{frame,μ} of slots per frame, and the number of slots per subframe in each subcarrier spacing configuration u in the case of the extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

In the early days when the 5G system was introduced, the coexistence or dual mode operation with the conventional LTE and/or LTE-A (hereinafter, referred to as LTE/LTE-A) systems was expected. Accordingly, conventional LTE/LTE-A may provide stable system operation to the UE, and the 5G system may serve to provide improved services to the UE. Therefore, the frame structure of the 5G system needs to include at least the frame structures of LTE/LTE-A or a necessary parameter set (e.g., subcarrier spacing=15 kilohertz (kHz)).

For example, in comparison between the frame structure (hereinafter, referred to as frame structure A) where the subcarrier spacing configuration μ=0 and the frame structure (hereinafter, referred to as frame structure B) where the subcarrier spacing configuration μ=1, the subcarrier spacing and the RB size become two times larger and the slot length and the symbol length become two time smaller in frame structure B compared to frame structure A. In the case of frame structure B, two slots constitute one subframe, and 20 subframes may constitute one frame.

When the frame structure of the 5G system is generalized, the subcarrier spacing, the CP length, and the slot length that correspond to the necessary parameter set have the relation of an integer multiple for respective frame structures, thereby providing high expandability. In order to indicate a reference time unit regardless of the frame structure, a subframe having the fixed size of 1˜˜ms may be defined.

The frame structures may be applied to correspond to various scenarios. From the viewpoint of cell size, a larger cell can be supported as the CP length is longer, so that frame structure A may support a relatively larger cell than frame structure B. From the viewpoint of the operation frequency band, longer subcarrier spacing is advantageous for reconstruction of phase noise of a high-frequency band, and thus frame structure B may support a relatively higher operation frequency than frame structure A. From the viewpoint of service, as the slot length, which is the basic time unit of scheduling, is shorter, it is more advantageous to support an ultra-low-latency service like URLLC, so that frame structure B is relatively more suitable for the URLLC service than frame structure A.

In the following description of the disclosure, an uplink (UL) may indicate a radio link through which the UE transmits data or a control signal to the BS and a downlink (DL) may indicate a radio link through which the BS transmits a data or a control signal to the UE.

In an initial access step in which the UE initially accesses the system, the UE may synchronize the downlink time and frequency on the basis of a synchronization signal transmitted by the BS through a cell search and acquire a cell ID. The UE may receive a physical broadcast channel (PBCH) by using the acquired cell ID and acquire a master information block (MIB) that is necessary system information from the PBCH. In addition, the UE may receive a system information block (SIB) transmitted by the BS and acquire cell common transmission and reception-related control information. The cell common transmission and reception-related control information may include random access (RA)-related control information, paging-related control information, and common control information for various physical channels.

A synchronization signal is a signal that is a reference of a cell search, and subcarrier spacing may be applied to fit a channel environment such as phase noise in each frequency band. In the case of a data channel or a control channel, in order to support various services as described above, subcarrier spacing may be adaptively applied according to a service type.

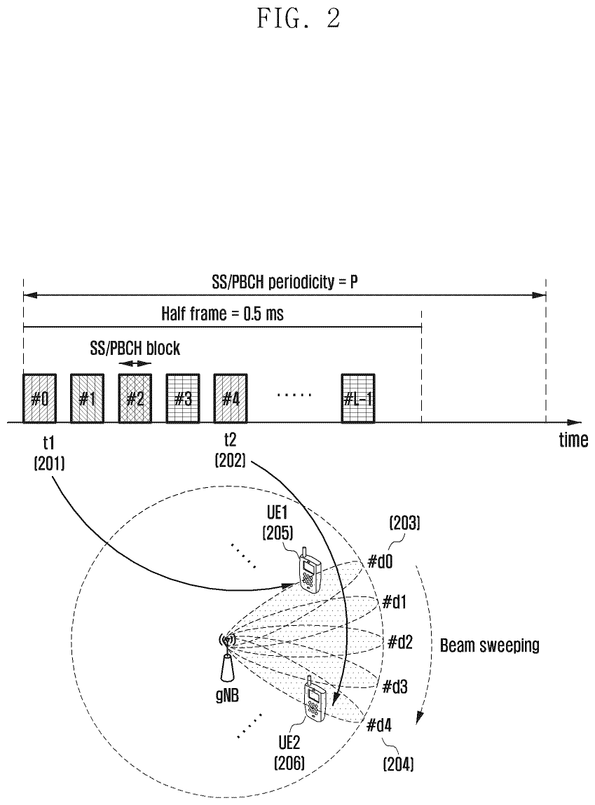

FIG. 2 illustrates a time domain mapping structure of a synchronization signal and a beam sweeping operation according to an embodiment of the disclosure.

Hereinafter, the following components may be predefined for description of the disclosure.
Primary synchronization signal (PSS): is a signal that is a reference of DL time/frequency synchronization may provide some information of the cell ID.
Secondary synchronization signal (SSS): is a signal that is a reference of DL time/frequency synchronization and may provide some pieces of the remaining information of the cell ID. In addition, the SSS serves as a reference signal for demodulation of a PBCH.
Physical broadcast channel (PBCH): may provide a master information block (MIB) that is necessary system information required for transmitting and receiving a data channel and a control channel by the UE. The necessary system information may include search space-related control information indicating radio resource mapping information of a control channel, scheduling control information for a separate data channel for transmitting system information, a system frame number (SFN) corresponding to a frame unit index that is a timing reference, and the like.
Synchronization signal/PBCH block (SS/PBCH block or SSB): the SS/PBCH block may be constituted by N OFDM symbols and include a combination of a PSS, a SSS, a PBCH, and the like. In the case of a system to which the beam sweeping technology is applied, the SS/PCH block may be a minimum unit to which the beam sweeping is applied. In the 5G system, N may be 4. The BS may transmit a maximum of L SS/PBCH blocks, and the L SS/PBCH blocks may be mapped within a half frame (0.5 ms). The L SS/PBCH blocks may be periodically repeated in units of P corresponding to a predetermined period. The BS may inform the UE of the period P through signaling. When there is no separate signaling for the period P, the UE may apply a pre-appointed default value.

FIG. 2 illustrates an example where the beam sweeping is applied in units of SS/PBCH blocks according to the passage of time. Referring to FIG. 2, UE #1 205 may receive an SS/PBCH block through a beam radiated in direction #d0 203 by beamforming applied to SS/PBCH block #0 at a time point t1 201. UE #2 206 may receive an SS/PBCH block through a beam radiated in direction #d4 204 by beamforming applied to SS/PBCH block #4 at a time point t2 202. The UE may acquire, from the BS, an optimal synchronization signal through a beam radiated in the direction in which the UE is located. For example, UE #1 205 has difficulty in acquiring time/frequency synchronization and necessary system information from the SS/PBCH block through the beam radiated in direction #d4, far away from the location of UE #1.

In addition to the initial access procedure, the UE may receive the SS/PBCH block in order to determine whether a radio link quality of a current cell is maintained to be higher than or equal to a predetermined level. Further, during a handover procedure in which the UE moves from the current cell to an adjacent cell, the UE may receive an SS/PBCH block of the adjacent cell in order to determine a radio link quality of the adjacent cell and acquire time/frequency synchronization of the adjacent cell.

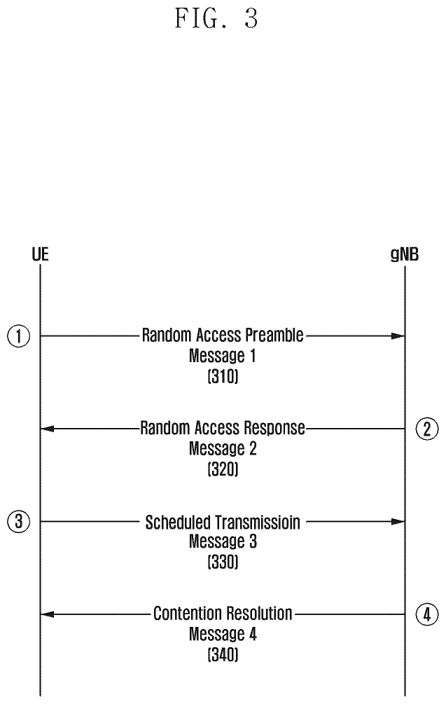

After acquiring the MIB and system information from the BS through the initial access procedure, the UE may perform a random access procedure to switch the link with the BS to a connected state (or an RRC_CONNECTED state). When the random access procedure is completed, the UE may switch to the connected state (or RRC_CONNECTED state), and one-to-one communication becomes possible between the BS and the UE. Hereinafter, the random access procedure is described in detail with reference to FIG. 3.

FIG. 3 illustrates a flow of signals for random access (RA) according to an embodiment of the disclosure.

The disclosure is not limited to a 4-step random access procedure illustrated in FIG. 3, and may also be applied to a 2-step random access procedure (message A (message including information corresponding to message 1 and message 3) transmission and reception and message B (message including information corresponding to message 2 and message 4) transmission and reception). That is, in description of an embodiment of the disclosure, message 1/3 may be replaced with message A. Further, in description of an embodiment of the disclosure, message 2/4 may be replaced with message B.

Referring to FIG. 3, at operation 310 according to an embodiment, the UE may transmit a random access preamble to the BS. In the random access procedure, the random access preamble corresponding to an initial transmission message may be referred to as message 1. The BS may measure a transmission delay value between the UE and the BS from the random access preamble and achieve uplink synchronization. At this time, the UE may randomly select a random access preamble to be used from a random access preamble set given in advance by system information. Initial transmission power of the random access preamble may be determined according to pathloss between the BS and the UE, measured by the UE. Further, the UE may determine a transmission beam direction of the random access preamble from the synchronization signal received from the BS and transmit the random access preamble.

At operation 320 according to an embodiment, the BS may transmit a random access response (RAR) (or message 2) in response to the random access preamble received at operation 310. The BS may transmit an uplink transmission timing control command to the UE, based on the transmission delay value measured from the random access preamble. As scheduling information, the BS may transmit, to the UE, an uplink resource and power control command to be used by the UE. The scheduling information transmitted by the BS may include control information for an uplink transmission beam of the UE.

When the UE does not receive the random access response (RAR or message 2) corresponding to scheduling information for message 3 from the BS within a predetermined time at operation 320, operation 310 may be performed again. When operation 310 is performed again, the UE may increase transmission power of the random access preamble by a predetermined step and transmit the random access preamble (e.g., power ramping), so as to increase a random access preamble reception probability of the BS.

At operation 330 according to an embodiment, the UE may transmit uplink data (that is, message 3) including its own UE ID to the BS through uplink resources allocated at operation 320. The UE may transmit uplink data including a UE identifier (ID) to the BS through an uplink data channel (physical uplink shared channel (PUSCH)). Transmission timing of the uplink data channel for transmitting message 3 may follow a timing control command received from the BS at operation 320. Transmission power of the uplink data channel for transmitting message 3 may be determined in consideration of the power control command received from the BS and a power ramping value of the random access preamble at operation 320. The uplink data channel for transmitting message 3 may be an initial uplink data signal which the UE transmits to the BS after the UE transmits the random access preamble.

When the BS determines that the UE perform random access without any collision with another UE, the BS may transmit data (that is, message 4) including an ID of the UE having transmitted the uplink data at operation 330 to the UE at operation 340 according to an embodiment. The UE may determine that the random access is successful when the signal transmitted by the BS at operation 340 is received. The UE may transmit hybrid automatic repeat request acknowledgement (HARQ-ACK) information indicating whether message 4 is successfully received to the BS through an uplink control channel (physical uplink control channel (PUCCH)).

When the BS fails in reception of the data signal from the UE due to collision between the data transmitted by the UE at operation 330 and data from another UE, the BS may not transmit data to the UE anymore. When the UE does not receive the data transmitted from the BS at operation 340 within a predetermined time, it may be determined that the random access procedure has failed and the procedure may be performed again from operation 310.

When the UE successfully completes the random access procedure, the UE may switch to the connected state (or RRC_CONNECTED state), and one-to-one communication may become possible between the BS and the UE. The BS may receive a report on UE capability information from the UE in the connected state (or RRC_CONNECTED state) and control scheduling with reference to the UE capability information of the corresponding UE. The UE may inform the BS of information indicating whether the UE itself supports a predetermined function, a maximum allowable value of the function supported by the UE, and the like through the UE capability information. Accordingly, UE capability information that each UE reports to the BS may be a different value for each UE.

For example, the UE reports UE capability information including at least one piece of the following control information to the BS.
Control information related to frequency bands supported by the UE
Control information related to channel bandwidths supported by the UE
Control information related to a maximum modulation scheme supported by the UE
Control information related to the maximum number of beams supported by the UE
Control information related to the maximum number of layers supported by the UE
Control information related to CSI reporting supported by the UE
Control information indicating whether the UE supports frequency hopping
Control information related to bandwidth when carrier aggregation (CA) is supported
Control information indicating whether cross carrier scheduling is supported when carrier aggregation is supported

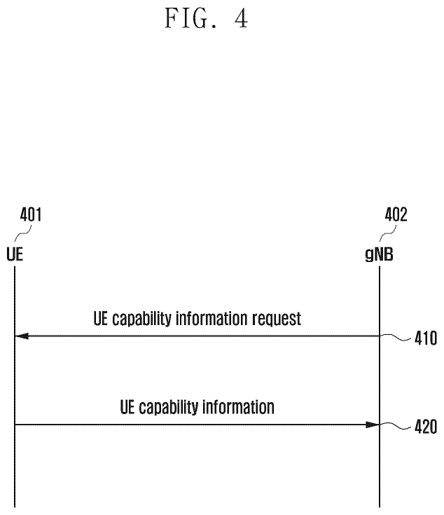

FIG. 4 illustrates the flow of signals for a report on UE capability information to the BS by the UE according to an embodiment of the disclosure.

Referring to FIG. 4, at operation 410 according to an embodiment, a gNB (BS) 402 may transmit a UE capability information request message to a UE 401.

At operation 420 according to an embodiment, the UE 401 may transmit UE capability information to the gNB, based on a UE capability information request from the gNB 402.

According to an embodiment, the UE 401 may transmit UE capability information to the gNB 402 regardless of the UE capability information request from the gNB 402. That is, the UE may report capability information without any explicit request from the gNB. In this case, operation 410 may be omitted.

Based on a process of transmitting and receiving UE capability information, the UE connected to gNB may perform one-to-one communication with the gNB as a UE in the RRC_CONNECTED state. The UE in the RRC_CONNECTED state may perform the following operation.
Monitor a downlink control channel (physical downlink control channel (PDCCH))
Measure a serving cell and neighboring cells and report the measurement to the BS
Monitor a radio link

First, monitoring of the downlink control channel of the UE in the RR_CONNECTED state is described in detail. When discontinuous reception (DRX) is not configured by the BS, a MAC entity of the UE may continuously monitor the PDCCH. When DRX is configured in the MAC entity of the UE by a higher-layer signal from the BS, the MAC entity of the UE may discontinuously monitor the PDCCH for all of activated serving cells by using the DRX operation. The UE may receive DRX operation-related parameters (e.g., including at least one of DRX cycle, drx-onDurationTimer, drx-InactivityTimer, or drx-SlotOffset) from the BS through a higher-layer signal and discontinuously monitor the PDCCH, based on the parameters. In the disclosure, monitoring the PDCCH through DRX by the UE in the RRC_CONNECTED state may be expressed as performing a connected-DRX (C-DRX) operation or performing C-DRX.

Subsequently, an operation of measuring a serving cell and neighboring cells of the UE in the RRC_CONNECTED state and reporting the measurement to the BS is described in detail. The UE may receive, from the BS, information on a target to be measured (e.g., whether a signal to be measured is an SSB or a CSI-RS, the location of frequency and time resources of a signal to be measured, a cell ID, and the like), configurations related to UE reporting (e.g., a signal type, whether metric is reference signal received power (RSRP), reference signal received quality (RSRQ), signal to interference-plus-noise ratio (SINR) per cell or per beam, the maximum number of cells/the maximum number of beams, information indicating which event measures the value on which the report is to be triggered, a measured cell ID, and the like), configurations required for measurement (e.g., RSRP, RSRQ, a SSB per SINR, or a filter coefficient for the CSI-RS), receive information on a measurement gap and the like, perform measurement based on the received information, and report the measured value to the BS. The measurement gap has been introduced to measure neighboring cells, based on SSB, within a SSB measurement timing configuration (SMTC) window when the neighboring cells in an intra- or inter-frequency compared to the serving cell of the UE in the RRC_CONNECTED state. For the measurement gap, a plurality of gap patterns has been defined in the standard for each gap pattern ID, and an ID of one of the gap patterns may be configured from the BS through a higher-layer signal or each gap pattern ID may be configured for each of FR1 and FR2 from the BS through a higher-layer signal. Table 4 below shows gap pattern configurations defined in the standard. In Table 4 below, each gap pattern is constituted by a gap pattern ID, a measurement gap length, and a measurement gap repetition period. In each gap pattern, the measurement gap of the measurement gap length is repeated by the measurement gap repetition period, and the UE performs measurement on neighboring cells in the repeated measurement gap.

TABLE 4
Table: gap pattern configurations

| | Measurement | Measurement Gap |
|---|---|---|
| Gap | Gap | Repetition |
| Pattern | Length | Period |
| Id | (MGL, ms) | (MGRP, ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 5.5 | 20 |
| 13 | 5.5 | 40 |
| 14 | 5.5 | 80 |
| 15 | 5.5 | 160 |
| 16 | 3.5 | 20 |
| 17 | 3.5 | 40 |
| 18 | 3.5 | 80 |
| 19 | 3.5 | 160 |
| 20 | 1.5 | 20 |
| 21 | 1.5 | 40 |
| 22 | 1.5 | 80 |
| 23 | 1.5 | 160 |
| 24 | 10 | 80 |
| 25 | 20 | 160 |

When the gap pattern is configured in the UE and the gap pattern arrives, the UE may perform measurement of the neighboring cell in the remaining intervals except for a switching time for an RF change between frequencies of the serving cell and the neighboring cell at both ends of the gap pattern length. Further, a start time of the gap pattern may be additionally controlled by a measurement gap timing advance (MGTA). The MGTA may be configured in the UE by a higher-layer signal. Since the UE changes the RF to a neighboring cell frequency during the measurement gap, the serving cell cannot perform transmission and reception with the BS and does not need the transmission and reception during the measurement gap.

Subsequently, radio link monitoring of the UE in the RRC_CONNECTED state is described in detail. The UE may perform radio link monitoring for the serving cell (or a primary serving cell, that is, PCell when carrier aggregation is configured) by using a channel state information reference signal (CSI-RS) or a SS/PBCH signal. Performing the radio link monitoring may mean that measuring a quality of a radio link by using the signals and determining whether the radio link is in-sync or out-of-sync. A signal used to perform the radio link monitoring among the CSI-RS and the SS/PBCH signal may be configured after a higher-layer signal is received from the BS.

When the quality of the radio link is measured, an evaluation period for measuring and evaluating whether the radio link is in-sync or out-of-sync is described. Whether DRX for PDCCH monitoring is configured by the BS may be determined and, when the DRX is configured, an in-sync evaluation period and an out-of-sync evaluation period may be differently determined according to a DRX period value.

Subsequently, an indication period on which in-sync or out-of-sync for which a physical layer of the UE is evaluated is transmitted to a higher layer of the UE is described as a result of the measurement and the evaluation. When the DRX is not configured, the indication period may be determined between the shortest period of resources for the radio link monitoring and 10 ms. On the other hand, when the DRX is configured, the indication period may be determined between the shortest period of resources for the radio link monitoring and the DRX period.

The in-sync is described. When the radio link quality is higher than a threshold Q_in received from the configurations of the BS for predetermined resources in a resource set for the radio link monitoring, the physical layer of the UE transmits in-sync to a higher layer of the UE in a frame in which the radio link quality has been evaluated. In order to determine in-sync of the radio link quality, the UE determines whether a block error rate (BLER) is smaller than a specific value (e.g., 2%) in the case where PDCCH decoding is performed from hypothetical downlink control channel (hypothetical PDCCH) parameters. The PDCCH parameters may be differently determined according to which signal is used for radio link monitoring.

In description of the out-of-sync, when the radio link quality is lower than a threshold Q_out received from the configurations of the BS for predetermined resources in a resource set for the radio link monitoring, the physical layer of the UE transmits out-of-sync to a higher layer of the UE in a frame in which the radio link quality has been evaluated. In order to determine out-of-sync of the radio link quality, the UE determines whether a block error rate is higher than 10% in the case where PDCCH decoding is performed from hypothetical downlink control channel parameters. The downlink control channel parameters may be differently determined according to which signal is used to perform radio link monitoring.

The higher layer of the UE (or the UE) initiates a timer T310 after receiving N310 successive out-of-sync. When the UE receives N311 successive in-sync, the timer T310 stops. Otherwise, the UE declares radio link failure (RLF) and initiates a timer T311. The UE performs cell selection in order to discover a suitable cell. When the suitable cell is not discovered and the timer T311 expires, the UE transitions to an RRC_IDLE state. When the suitable cell is discovered, the timer T311 stops and the UE transmits a RRC reestablishment request message to a BS of the cell and initiates a timer T301. When the RRC reestablishment operation is not successfully completed and the timer T301 expires, the UE transitions to the RRC_IDLE state. When the RRC reestablishment operation is successfully completed within the T301 timer, the UE transitions to the normal RRC_CONNECTED state.

The parameters and timers for performing procedures related to the radio link monitoring and the radio link failure, such as N310, the timer T310, N311, the timer T311, and the timer T301 may be configured in the UE by a higher-layer signal from the BS.

On the other hand, the UE which is not connected to the BS may be in the RRC_IDLE state, and the UE in the RRC_IDLE state may perform the following process.
Perform a UE-specific discontinuous reception (DRX) cycle configured by a higher layer
Receive a paging message from a core network
Acquire system information
Serving cell (or cell that camps on)-related measurement operation and cell selection/reselection
Neighboring cell-related measurement operation and cell reselection

In more detailed description of the serving cell (or cell that camps on)-related measurement operation and the cell selection/reselection (referred to as main radio (MR) radio resource management (RRM) measurement/evaluation in the disclosure), the UE may measure SS-RSRP and an SS-RSRP level in at least every M1*N1 DRX cycle for the serving cell (or cell that camps on) and evaluate the cell selection determination reference S, based on the measured value. When a SSB-based measurement timing configuration (SMTC) period is higher than 20 ms and a DRX cycle is equal to or lower than 0.64 s, M1=2, and otherwise, M1=1

N1 may be determined by Table 5 below.

TABLE 5

| | | | | Nₛₑᵣᵥ |
|---|---|---|---|---|
| DRX | N1 | | | [number of DRX |
| cycle[s] | FR1 | FR2-1 | FR2-2 | cycles] |
| 0.32 | 1 | 8 | 12 | M1*N1*4 |
| 0.64 | | 5 | 8 | M1*N1*4 |
| 1.28 | | 4 | 6 | N1*2 |
| 2.56 | | 3 | 5 | N1*2 |

The cell selection determination reference S may be satisfied when Sᵣₓₗₑᵥ corresponding to SS-RSRP>0 and S_{qual} corresponding to SS-RSRQ>0.
Sᵣₓₗₑᵥ=Qᵣₓₗₑᵥₘₑₐₛ−(Qᵣₓₗₑᵥₘᵢₙ+Q_{rxlevminoffset})−P_{compensation}−Q_{offsettemp}
S_{qual}=Q_{qualmeas}−(Q_{qualmin}+Q_{qualminoffset})−Q_{offsettemp}

Qᵣₓₗₑᵥₘₑₐₛ denotes measured SS-RSRP, Q_{qualmeas} denotes measured SS-RSRQ, Qᵣₓₗₑᵥₘᵢₙ denotes a level of the size of a minimally required reception signal in the serving cell and may be received by the UE through system information, and Q_{qualmin} denotes a level of the quality of a minimally required reception signal in the serving cell and may be received by the UE through system information. For description of the parameters, refer to Table 6.

TABLE 6

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 [3] |
| | (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports SUL frequency for this cell, Qᵣₓₗₑᵥₘᵢₙ is obtained from q- |
| | RxLevMinSUL, if present, in SIB1, SIB2 and SIB4, additionally, if |
| | Q_{rxlevminoffsetcellSUL} is present in SIB3 and SIB4 for the concerned |
| | cell, this cell specific offset is added to the corresponding |
| | Qrxlevmin to achieve the required minimum RX level in the |
| | concerned cell; |
| | else Qᵣₓₗₑᵥₘᵢₙ is obtained from q-RxLevMin in SIB1, SIB2 and |
| | SIB4, additionally, if Q_{rxlevminoffsetcell} is present in SIB3 and SIB4 |
| | for the concerned cell, this cell specific offset is added to the |
| | corresponding Qrxlevmin to achieve the required minimum RX |
| | level in the concerned cell. |
| Q_{qualmin} | Minimum required quality level in the cell (dB). Additionally, if |
| | Q_{qualminoffsetcell} is signaled for the concerned cell, this cell specific |
| | offset is added to achieve the required minimum quality level in |
| | the concerned cell. |
| Q_{rxlevminoffset} | Offset to the signaled Qᵣₓₗₑᵥₘᵢₙ taken into account in the Srxlev |
| | evaluation as a result of a periodic search for a higher priority |
| | PLMN while camped normally in a VPLMN, as specified in TS |
| | 23.122 [9]. |
| Q_{qualminoffset} | Offset to the signaled Q_{qualmin} taken into account in the Squal |
| | evaluation as a result of a periodic search for a higher priority |
| | PLMN while camped normally in a VPLMN, as specified in TS |
| | 23.122 [9]. |
| P_{compensation} | For FR1, if the UE supports the additionalPmax in the NR-NS- |
| | PmaxList, if present, in SIB1, SIB2 and SIB4: |
| | max(P_{EMAX1} − P_{PowerClass}, 0) − (min(P_{EMAX2}, P_{PowerClass}) − |
| | min(P_{EMAX1}, PPowerClass)) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, | Maximum TX power level of a UE may use when transmitting on |
| P_{EMAX2} | the uplink in the cell (dBm) defined as P_{EMAX} in TS 38.101 [15]. |
| | If UE supports SUL frequency for this cell, P_{EMAX1} and P_{EMAX2} are |
| | obtained from the p-Max for SUL in SIB1 and NR-NS-PmaxList |
| | for SUL respectively in SIB1, SIB2 and SIB4 as specified in TS |
| | 38.331 [3], else P_{EMAX1} and P_{EMAX2} are obtained from the p-Max |
| | and NR-NS-PmaxList respectively in SIB1, SIB2 and SIB4 for |
| | normal UL as specified in TS 38.331 [3]. |
| P_{PowerClass} | Maximum RF output power of the UE (dBm) according to the UE |
| | power class as defined in TS 38.101-1 [15]. |

When determining the measured SS-RSRP, the UE may determine the SS-RSRP of the serving cell by performing filtering from at least two measurement values spaced apart by the half of the at least DRX cycle. Further, when determining the measured SS-RSRQ, the UE may determine the SS-RSRQ of the serving cell by performing filtering from at least two measurement values spaced apart by the half of the at least DRX cycle.

When the UE determines that the serving cell does not satisfy the cell selection determination reference S during Nₛₑᵣᵥ successive DRX cycles, the UE may initiate measurement of all of the neighboring cells except the serving cell. When the UE has not discovered a new suitable cell for 10 s, the UE may initiate a cell selection procedure for the selected public land mobile network (PLMN).

In the 5G system, in order to reduce energy and time consumed for initial access of the UE, a UE in a new state such as RRC_INACTIVE is defined. The RRC_INACTIVE UE may perform the following process in addition to the operations performed by the RRC_IDLE UE.
Store access stratum (AS) information required for cell access
UE-specific DRX cycle operation configured by an RRC layer.
Configure and periodically update a radio access network (RAN)-based notification area (RNA) that can be used for handover by an RRC layer
Monitor a RAN-based paging message transmitted through an inactive-radio network temporary identifier (I-RNTI)

The UE in the RRC_CONNECTED state may receive an RRC release indication from the BS and may switch from the RRC_CONNECTED state to the RRC_INACTIVE or RRC_IDLE state.

The UE in the RRC_INACTIVE or RRC_IDLE state may complete all random access procedures by performing random access and switch from the RRC_INACTIVE or RRC_IDLE state to the RRC_CONNECTED state.

Hereinafter, a scheduling method by which the BS transmits downlink data to the UE or indicates transmission of uplink data by the UE is described.

Downlink control information (DCI) may be control information that the BS transmits to the UE through the downlink. The downlink control information may include downlink data scheduling information or uplink data scheduling information for a predetermined UE. In general, after independently perform channel coding on DCI for each UE, the BS may perform transmission to each UE through a physical downlink control channel (PDCCH) corresponding to a downlink physical control channel.

The BS may apply a predetermined DCI format to a UE to be scheduled according to the purposes, such as whether the data is scheduling information for downlink data (downlink assignment), whether the data is scheduling information for uplink data (uplink grant), or whether the data is DCI for power control, and operate the UE.

The BS may transmit downlink data through a physical downlink shared channel (PDSCH) corresponding to a physical channel for downlink data transmission. The BS may inform the UE of the scheduling information, such as the detailed mapping location of the PDSCH in time and frequency domains, a modulation scheme, HARQ-related control information, and power control information, through DCI related to downlink data scheduling information among DCI transmitted through the PDCCH.

The UE may transmit uplink data to the BS through a physical uplink shared channel (PUSCH) corresponding to a physical channel for uplink data transmission. The BS may inform the UE of the scheduling information, such as the detailed mapping location of the PDSCH in time and frequency domains, a modulation scheme, HARQ-related control information, and power control information, through DCI related to uplink data scheduling information among DCI transmitted through the PDCCH.

Time-frequency resources to which the PDCCH is mapped may be referred to as a control resource set (CORESET). The CORESET may be configured in all or some of the frequency resources of the bandwidths supported by the UE in the frequency domain. The control resource set may be configured as one or a plurality of OFDM symbols in the time domain, which may be defined as a control resource set length (CORESET duration). The BS may configure one or a plurality of CORESETs in the UE through higher-layer signaling (e.g., system information, a master information block (MIB), or radio resource control (RRC) signaling). Configuring the CORESET in the UE by the BS may mean that the BS provides information, such as a CORESET identity, a frequency location of the CORESET, and a symbol length of the CORESET, to the UE. The information that the BS provides to the UE to configure the CORESET may include at least some pieces of the information included in Table 7 below.

TABLE 7

| | |
|---|---|
| ControlResourceSet ::= | SEQUENCE { |
| controlResourceSetId | , |

(CORESET ID)

| | |
|---|---|
| frequencyDomainResources | BIT STRING (SIZE (45)), |

(frequency domain resources)

| | |
|---|---|
| duration | INTEGER (1..maxCoReSetDuration), |

(CORESET duration)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| interleaverSize | ENUMERATED {n2, n3, n6}, |

(interleaver size)

| | |
|---|---|
| shiftIndex | INTEGER(0..maxNrofPhysicalResourceBlocks-1) |

```
OPTIONAL -- Need S
          (interleaver shift)
      },
```

| | |
|---|---|
| nonInterleaved | NULL |

},

| | |
|---|---|
| precoderGranularity | ENUMERATED { sameAsREG-bundle, |

allContiguousRBs},
(precoding unit)

| | |
|---|---|
| tci-StatesPDCCH-ToAddList | SEQUENCE(SIZE (1..maxNrofTCI- |

```
StatesPDCCH)) OF TCI-StateId OPTIONAL, -- Cond NotSIB1-initialBWP
    (QCL configuration information)
  tci-StatesPDCCH-ToReleaseList SEQUENCE(SIZE (1..maxNrofTCI-
StatesPDCCH)) OF TCI-StateId OPTIONAL, -- Cond NotSIB1-initialBWP
    (QCL configuration information)
```

| | |
|---|---|
| tci-PresentInDCI | ENUMERATED {enabled} |

OPTIONAL, -- Need S
(QCL indicator configuration information within DCI)

| | |
|---|---|
| pdcch-DMRS-ScramblingID | INTEGER (0..65535) |

OPTIONAL, -- Need S
(PDCCH DMRS scrambling ID)
}

The CORESET may be constituted by in the frequency domain and N_{symb}^{CORBSBT}∈{1,2,3} symbols in the time domain. A NR PDCCH may be constituted by one or a plurality of control channel elements (CCEs). one CCE may be constituted by 6 resource element groups (REGs), and the REG may be defined as 1 RB during 1 OFDM symbol. In REGs within one CORESET, REG indexes, starting at REG index 0, may be assigned in a time-first order from the lowest RB in a first OFDM symbol of the CORESET.

An interleaved scheme and a non-interleaved scheme may be supported for a PDCCH transmission method. The BS may configure whether to perform interleaving or non-interleaving transmission for each CORESET in the UE through higher-layer signaling. Interleaving may be performed in units of REG bundles. The REG bundle may be defined as one or a set of a plurality of REGs. The UE may determine a CCE-to-REG mapping scheme in the corresponding CORESET as the following scheme shown in Table 8 below, based on the information indicating whether to perform interleaving or non-interleaving transmission configured by the BS.

TABLE 8
The CCE-to-REG mapping for a control-resource set can be interleaved or non-
interleaved and is described by REG bundles:

| | |
|---|---|
| - | REG bundle i is defined as REGs {iL,iL+ 1,...,iL+L−1} where L is the REG |
| | bundle size, i = 0,1,..., N_{REG}^{CORESET} /L − 1, and N_{REG}^{CORESET} = N_{RB}^{CORESET} N_{symb}^{CORESET} is |
| | the number of REGs in the CORESET |
| - | CCE j consists of REG bundles {f(6j)/L), f(6j/L+1),..., f(6j/L+6/L−1)} where |
| | f(•) is an interleaver |

For non-interleaved CCE-to-REG mapping, L = 6 and f(x) = x.
For interleaved CCE-to-REG mapping, L ∈ {2,6}for N_{symb}^{CORESET} = 1 and
L ∈ {N_{symb}^{CORESET} ,6} for N_{symb}^{CORESET} ∈ {2,3}. The interleaver is defined by

```
  f(x) = (rC + c + n_{shift}) mod (N_{REG}^{CORESET} /L)
        x = cR + r
      r = 0,1, ..., R − 1
      c = 0,1, ..., C − 1
    C = N_{REG}^{CORESET} /(LR)
```

where R ∈ {2,3,6}.

The BS may inform the UE of information on symbols to which the PDCCHs are mapped within the slot and configuration information, such as a transmission period, through signaling.

A search space of the PDCCH is described below. The number of CCEs required to transmit the PDCCH may be 1, 2, 4, 8, or 16 according to the aggregation level (AL), and the different numbers of CCEs may be used for link adaptation of the downlink control channel. For example, in the case of AL=L, one downlink control channel is transmitted through L CCEs. The UE performs blind decoding of detecting a signal in the state in which the UE is not aware of information on the downlink control channel, and a search space indicating a set of CCEs may be defined for the blind decoding. The search space is a set of downlink control channel candidates including CCEs for which the UE should attempt decoding at the given aggregation level, and there are several aggregation levels at which one set of CCEs is configured by 1, 2, 4, 8, and 16 CCEs, so that the UE may have a plurality of search spaces. The search space set may be defined as a set of search spaces at all of the configured aggregation levels.

The search spaces may be classified into a common search space (CSS) and a UE-specific search space (USS). UEs in a predetermined group or all UEs may search for a common search space of the PDCCH in order to receive cell-common control information such as dynamic scheduling for system information (system information block (SIB)) or paging messages. For example, the UE receives scheduling allocation information of the PDSCH for receiving system information by searching for the common search space of the PDCCH. In the case of the common search space, UEs in a predetermined group or all UEs should receive the PDCCH, and thus the common search space may be defined as a set of pre-arranged CCEs. Scheduling allocation information for the UE-specific PDSCH or PUSCH may be received by searching for a UE-specific search space of the PDCCH. The UE-specific search space may be UE-specifically defined by a UE identity (ID) and a function of various system parameters.

The BS may configure configuration information of the search space of the PDCCH in the UE through higher-layer signaling (e.g., SIB, MIB, or RRC signaling). For example, the BS configures, in the UE, the number of PDCCH candidates at each aggregation level L, a monitoring period of the search space, a monitoring occasion in units of symbols within the slot for the search space, a search space type (a common search space or a UE-specific search space), a combination of an RNTI and a DCI format to be monitored in the corresponding search space, a CORESET index for monitoring the search space, and the like. For example, parameters for the search space of the PDCCH includes information shown in Table 9 below.

TABLE 9

| | |
|---|---|
| SearchSpace ::= | SEQUENCE { |
| searchSpaceId | , |

(search space ID)

| | |
|---|---|
| controlResourceSetId | OPTIONAL, -- Cond SetupOnly |

```
    (CORESET ID)
  monitoringSlotPeriodicityAndOffset CHOICE {
    (monitoring slot level period and offset)
```

| sl1 | NULL, | |
|---|---|---|
| sl2 | INTEGER (0..1), | |
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639), | |
| sl1280 | INTEGER (0..1279), | |
| sl2560 | INTEGER (0..2559) | |
| } | | OPTIONAL, -- Cond Setup |
| duration | INTEGER (2..2559) | OPTIONAL, -- |

Need R
(monitoring duration)

| | |
|---|---|
| monitoringSymbolsWithinSlot | BIT STRING (SIZE (14)) |

OPTIONAL, -- Cond Setup
(monitoring symbol location within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

| | |
|---|---|
| } | OPTIONAL, -- Cond Setup |

| | |
|---|---|
| searchSpaceType | CHOICE { |

(search space type)

| | |
|---|---|
| common | SEQUENCE { |

(common search space)

| | |
|---|---|
| dci-Format0-0-AndFormat1-0 | SEQUENCE { |

...

| | |
|---|---|
| } | OPTIONAL, -- Need R |

| | |
|---|---|
| dci-Format2-0 | SEQUENCE { |
| nrofCandidates-SFI | SEQUENCE { |

| | |
|---|---|
| aggregationLevel1 | ENUMERATED {n1, n2} OPTIONAL, |

-- Need R

| | |
|---|---|
| aggregationLevel2 | ENUMERATED {n1, n2} OPTIONAL, |

-- Need R

| | |
|---|---|
| aggregationLevel4 | ENUMERATED {n1, n2} OPTIONAL, |

-- Need R

| | |
|---|---|
| aggregationLevel8 | ENUMERATED {n1, n2} OPTIONAL, |

-- Need R

| | |
|---|---|
| aggregationLevel16 | ENUMERATED {n1, n2} OPTIONAL |

```
-- Need R
          },
          ...
```

| | |
|---|---|
| } | OPTIONAL, -- Need R |

| | |
|---|---|
| dci-Format2-1 | SEQUENCE { |

...

| | |
|---|---|
| } | OPTIONAL, -- Need R |

| | |
|---|---|
| dci-Format2-2 | SEQUENCE { |

...

| | |
|---|---|
| } | OPTIONAL, -- Need R |

| | |
|---|---|
| dci-Format2-3 | SEQUENCE { |
| dummy1 | ENUMERATED {sl1, sl2, sl4, sl5, sl8, sl10, sl16, |

sl20} OPTIONAL, -- Cond Setup

| | |
|---|---|
| dummy2 | ENUMERATED {n1, n2}, |

...

| | |
|---|---|
| } | OPTIONAL -- Need R |

},

| | |
|---|---|
| ue-Specific | SEQUENCE { |

(UE-specific search space)

| | |
|---|---|
| dci-Formats | ENUMERATED {formats0-0-And-1-0, formats0- |

```
1-And-1-1},
        ...,
      }
```

| | |
|---|---|
| } | OPTIONAL -- Cond Setup2 |

}

Based on configuration information transmitted to the UE, the BS may configure one or a plurality of search space sets in the UE. According to an embodiment, the BS may configure search space set 1 and search space set 2 in the UE. The UE may be configured to monitor a DCI format A scrambled by a radio network temporary identifier (X-RNTI) in the common search space in search space set 1 and configured to monitor a DCI format B scrambled with a Y-RNTI in the UE-specific search space in search space set 2.

According to configuration information transmitted by the BS, one or a plurality of search space sets may exist in the common search space or the UE-specific search space. For example, search space set #1 and search space set #2 are configured as common search spaces, and search space set #3 and search space set #4 may be configured as UE-specific search spaces.

In the common search space, the UE may monitor the following combinations of DCI formats and RNTIs. According to various embodiments of the disclosure, the disclosure is not limited to the flowing examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the UE may monitor the following combinations of DCI formats and RNTIs. According to various embodiments of the disclosure, the disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI
RNTIs may comply with the following definition and purposes. According to various embodiments of the disclosure, the disclosure is not limited the following examples.
Cell RNTI (C-RNTI): used for UE-specific PDSCH or PUSCH scheduling
Temporary Cell RNTI (TC-RNTI): used for UE-specific PDSCH scheduling
Configured Scheduling RNTI (CS-RNTI): used for semi-statically configured UE-specific PDSCH scheduling
Random Access RNTI (RA-RNTI): used for PDSCH scheduling at random access stage
Paging RNTI (P-RNTI): used for PDSCH scheduling through which paging is transmitted
System information RNTI (SI-RNTI): used for PDSCH scheduling through which system information is transmitted
Interruption RNTI (INT-RNTI): used for indicating whether puncturing is performed for PDSCH
Transmit power control for PUSCH RNTI (TPC-PUSCH-RNTI): used for indicating PUSCH power control command
Transmit power control for PUCCH RNTI (TPC-PUCCH-RNTI): used for indicating PUCCH power control command
Transmit power control for SRS RNTI (TPC-SRS-RNTI): used for indicating SRS power control command

The DCI formats may comply with the definition as shown in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and PUSCH |
| 2_3 | Transmission of a group of TPC commands for |
| | SRS transmissions by one or more UEs |

A CORESET p and a search space at an aggregation level L in a search space set s may be expressed as shown in the following equation.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad Equation 1$$

L: aggregation level
nc_{CI}: carrier index
N_{CCE.p}: total number of CCEs existing within CORESET p
n^{μ}_{s,f}: slot index
M^{(L)}_{p,s,max}: number of PDCCH candidates at aggregation level L
m_{snCI}=0, . . . , M^{(L)}_{p,s,max}−1: PDCCH candidate index at aggregation level L
i=0, . . . , L−1

$${Y}_{p , {n}_{s , f}^{μ}} = ( {A}_{p} \cdot {Y}_{p , {n}_{s , f}^{μ} - 1} ) mod D , {Y}_{p - 1} = {n}_{RNTI} \neq 0 ,$$

$${A}_{0} = 39827 , {A}_{1} = 39829 , {A}_{2} = 39839 , D = 65537$$

n_{RNTI}: UE identifier

Y_{p,n}_{_{s,f}}^{μ} may correspond to 0 in the case of the common search space.

Y_{p,n}_{_{s,f}}^{μ} may correspond to a value varying depending on a UE ID (a C-RNTI or an ID configured in the UE by the BS) and a time index in the case of the UE-specific search space.

Hereinafter, embodiments of the disclosure will be described in detail with reference to the accompanying drawings. The BS is the entity that allocates resources to the UE, and may be at least one of a gNode B, a gNB, an eNode B, a Node B, a base station (BS), a radio access unit, a BS controller, and a node on a network. A terminal may include a user equipment (UE), a mobile station (MS), a cellular phone, a smart phone, a computer, or a multimedia system capable of performing a communication function. Hereinafter, although embodiments of the disclosure are described with an example of the 5G system, the embodiments of the disclosure may be applied to other communication systems having a similar technical background or channel form. For example, a mobile communication technology developed after LTE or LTE-A mobile communication and 5G is included therein. Accordingly, embodiments of the disclosure may be applied to other communication systems through some modifications without departing from the scope of the disclosure on the basis of a determination of those skilled in the art. For example, the content of the disclosure is applied to frequency division duplex (FDD), time division duplex (TDD), and cross division duplex (XDD) systems, and a subband full duplex (SBFD) system.

In description of the disclosure, detailed description of a relevant function or configuration is omitted if it is determined that the detailed description makes the subject of the disclosure unclear. The terms as described below are defined in consideration of the functions in the embodiments, and the meaning of the terms may vary according to the intention of a user or operator, convention, or the like. Therefore, the definitions of the terms should be made based on the contents throughout the specification.

In description of the disclosure, higher-layer signaling may be signaling corresponding to at least one of the following signaling or a combination of one or more thereof.
MIB (Master Information Block)
SIB (System Information Block) or SIB X (X=1, 2, . . . )
RRC (Radio Resource Control)
MAC (Medium Access Control) CE (Control Element)

L1 signaling may be signaling corresponding to at least one of or a combination of one or more of signaling methods using the following physical layer channels or signaling.
Physical downlink control channel (PDCCH)
Downlink control information (DCI)
UE-specific DCI
Group common DCI
Common DCI
Scheduling DCI (e.g., DCI used for scheduling downlink or uplink data)
Non-scheduling DCI (e.g., DCI other than DCI for scheduling downlink or uplink data)
Physical uplink control channel (PUCCH)
Uplink control information (UCI)

In the disclosure, the examples are described through a plurality of embodiments, but are not independent from each other and one or more embodiments may be simultaneously or complexly applied. In description of an embodiment of the disclosure, a main radio operation may be understood as an operation of the UE including main radio and/or an operation of a processor included in the UE including a main radio.

In description of an embodiment of the disclosure, a wakeup receiver operation may be understood as an operation of the UE including a wakeup receiver and/or an operation of a processor included in the UE including the wakeup receiver.

In description of an embodiment of the disclosure, unless specially mentioned, the main radio and/or the wakeup receiver may be used for signal/channel transmission and reception of the UE.

In description of an embodiment of the disclosure, smaller than (or smaller than a specific value) may be replaced with equal to or smaller than, and equal to or smaller than may be replaced with smaller than.

In description of an embodiment of the disclosure, larger than (or larger than a specific value) may be replaced with larger than or equal to, and larger than or equal to may be replaced with larger than.

In description of an embodiment of the disclosure, a/b may be at least one of a or b.

As described above, signal transmission and reception in an ultra-wide bandwidth of scores to hundreds of MHz or several GHz may be supported to achieve an ultra-high speed data service reaching several Gbps in the 5G system. The signal transmission and reception in the ultra-wide bandwidth may be supported through a single component carrier (CC) or supported through carrier aggregation (CA) technology of combining a plurality of component carriers. When a mobile communication service provider does not secure the frequency of the enough bandwidth to provide the ultra-high speed data service as the single component carrier, the carrier aggregation technology may increase a sum of frequency bandwidth by combining component carriers having relatively small bandwidth sizes and, as a result, make the ultra-high speed data service possible.

The 5G system is designed and developed for all of various use cases. In addition to latency, reliability, and availability, energy efficient of the UE is very important in the 5G system. A 5G UE is required to be charged in units of weeks or days according to the individual usage time and, in general, consumes tens of mW in the RRC_IDLE/RRC_INACTIVE state and hundreds of mW in the RRC_CONNECTED state. A design to extend battery life may not be only a better user experience but also a necessary element for improving energy efficiency. Energy efficiency may be more important to UE having no continuous energy source (e.g., UEs using small rechargeable and single coin cell batteries). In the 5G use cases, sensor and actuators are widely arranged to perform monitoring, measurement, charging, and the like and, in general, batteries are not rechargeable and may need to last at least several years. Further, wearable devices may include smart watches, rings, eHealth-related devices, medical monitoring devices, and the like and, in general, have difficulty in lasting up to 1 to 2 weeks according to the usage time.

Power consumption of the 5G UE depends on the configured length of wakeup periods (e.g., a paging cycle), and an extended discontinuous reception (eDRX) cycle having a large value may be used to meet battery life requirements. However, the eDRX scheme is not suitable for a low-latency service since the battery life is maintained to be long based on high latency. For example, in fire detection and extinguishing use cases, it should be required to close fire shutters and turn on sprinklers through actuators within 1 to 2 seconds from the time point at which fire is detected by sensors. In this case, latency may be important, and thus the existing long eDRX cycle cannot meet latency requirements. and is not suitable.

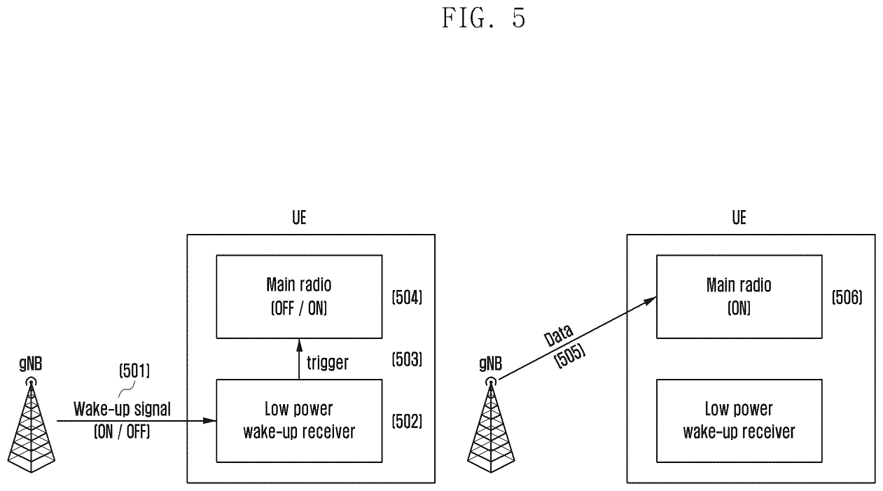

FIG. 5 illustrates state switching of a BS and a UE and an example of states of the UE depending on a BS state according to an embodiment of the disclosure. Specifically, FIG. 5 illustrates state switching of the BS and the UE to solve the above-described problem. Various modifications can be made to a method illustrated in FIG. 5. For example, although illustrated as a series of steps, various steps in the drawings overlaps, may be generated in parallel, may be generated in different orders, or may be generated several times. In another example, the steps may be omitted or replaced with other steps.

Referring to FIG. 5, the 5G UE (or a UE after 5G) may need to periodically wake up once per eDRX cycle, which may dominate power consumption during a period having no signaling or data traffic. If the UE wakes up only when the UE is triggered like paging, power consumption can be dramatically reduced. The dramatic power consumption reduction may be achieved through a method of triggering a main radio (e.g., the conventional NR radio) using a wake-up signal (WUS) as illustrated in FIG. 5 and turning on the main radio using a wake-up receiver (WUR) corresponding to a separate receiver capable of monitoring the WUS with ultra-low power only when data transmission and reception are needed.

Referring to FIG. 5, the BS may transmit a WUS corresponding to ON or OFF to the UE at operation 501 according to an embodiment. The BS may transmit the WUS to the UE and include ON information or OFF information.

At operation 502 according to an embodiment, the UE may receive the WUS using a wake-up receiver (WUR or a low power wake-up receiver).

At operation 503 according to an embodiment, the UE may trigger the main radio in the OFF or ON state, based on information indicating that the received signal corresponds to ON or OFF. For example, triggering the main radio means a triggering state switching of the main radio. For example, the triggering includes triggering the main radio in the OFF state to switch to the ON state or triggering the main radio in the ON state to switch to the OFF state, and the like.

At operation 504 according to an embodiment, the UE may configure the main radio to be woke up or turned off. For example, configuring the main radio to be turned off means the main radio is completely turned off. Alternatively, according to an embodiment, the main radio may be configured to be in a deep sleep (DS) state or an ultra-deep sleep (UDS) state rather than the completely turned off state. Whether the main radio is completely turned off or is in the DS or UDS state may be distinguished according to which component within the main radio can be turned off. For example, when the main radio is completely turned off, all components within the radio is OFF. When the main radio is in the DS state, an oscillator, a radio frequency-front end (RF-FE), and a baseband modem may be OFF, but a control processor and a double data rate (DDR) memory may be still ON. When the main radio is in the UDS state, an oscillator, a radio frequency-front end (RF-FE), and a baseband modem may be OFF, and a control processor and a double data rate (DDR) memory may operate with very low power or may be OFF.

When data traffic to be transmitted to the UE by the BS is generated and thus the WUS that the BS transmits at operation 501 is a signal corresponding to ON at operation 505 according to an embodiment, the main radio may be turned ON and the UE may receive the data transmitted by the BS through the main radio rather than the WUR at operation 506. That is, when the BS transmits the WUS corresponding to ON at operation 501, the main radio of the UE may be turned ON. The BS may transmit data at operation 505, and the UE receive the data through the main radio at operation 506.

According to an embodiment, since power consumption for monitoring the WUS depends on a hardware module of the WUR used for designing a WUS, and detecting and processing a signal, gains for use cases (such as industrial sensors and controller) of the Internet of things (IoT) and small form factor devices that include a wearable device and are sensitive to power can be maximized.

According to an embodiment, UE capability information related to the wake-up receiver may be supported. According to an embodiment, the UE including the wake-up receiver may report that the UE has a capability to wake up the main radio using the wake-up receiver to the BS or may report capability information indicating that the UE includes the wake-up receiver to the BS.

According to an embodiment, the UE may report capability information of the wake-up receiver to the BS through the procedure of reporting the UE capability information of FIG. 4.

According to an embodiment, the UE may report the capability information of the wake-up receiver to the BS through at least one step of a random access preamble or an uplink data channel during the random access procedure of FIG. 3. According to an embodiment, sets of random access preambles that can be transmitted by the UE including the wake-up receiver may be transmitted to the UE as system information. The UE may select a random access preamble from the sets received by the UE, and may transmit the random access preamble, based on the selected random access preamble, in operation 310 of the random access procedure of FIG. 3.

According to an embodiment, after reporting the capability information of the wake-up receiver to the BS, the UE may receive information indicating whether to use the wake-up receiver from the BS through higher-layer signaling or a physical signal.

According to an embodiment, when the BS supports the UE including the wake-up receiver (e.g., when the BS has hardware capable of transmitting a wake-up signal), the BS may determine whether to use the wake-up signal after receiving the capability information of the wake-up receiver from the UE.

According to an embodiment, the BS may transmit a signal indicating whether to use the wake-up receiver or configuration information for receiving the wake-up signal to the UE. For example, this is understood as permission or a permission procedure for the wake-up signal by the BS. According to an embodiment, the BS may transmit at least one piece of indication information for activating reception of the wake-up signal by the UE or the wake-up receiver or indication information indicating transmission of the wake-up signal by the BS to the UE. After slots configured by the BS and/or predefined (e.g., defined according to the standard) from the slot through which the signal (signal indicating configuration information for receiving the wake-up signal) is received, the UE may turn off the main radio and turn on the wake-up receiver for monitoring the wake-up signal. According to an embodiment, the UE may transmit at least one of feedback indicating that the signal indicating whether to use the wake-up receiver is received before the main radio is turned off or feedback indicating that the main radio is turned off and the wake-up receiver is turned on to the BS through the main radio.

According to an embodiment, when the BS does not support the UE having the wake-up receiver, the BS may transmit a signal indicating the use of the wake-up signal is not possible to the UE after receiving the capability information of the wake-up receiver from the UE. The UE may transmit feedback indicating reception of the signal indicating that the use of the wake-up signal is not possible to the BS. According to an embodiment, the UE may perform an operation by parameters of the existing power reduction method configured by the BS using the existing power reduction method (C-DRX or idle (I)-DRX such as paging).

According to various embodiments of the disclosure, after the procedure of reporting capabilities of the UE having the wake-up receiver and indicating whether to support (or permit) the wake-up receiver, the wake-up receiver of the UE may perform an operation of turning on and off the main radio of the UE by receiving the wake-up signal.

According to an embodiment, the UE may perform operation procedures of turning on/off the main radio, reporting the capabilities of the UE having the wake-up receiver, or indicating whether the BS supports the wake-up receiver may be performed independently of each other. For example, even when the operation of reporting the UE capability and the permission procedure are not performed, the BS transmits a signal indicating whether to use the wake-up receiver or configuration information for reception of the wake-up signal to the UE. Accordingly, among the UEs receiving the signal from the BS, the UE having the wake-up receiver may turn on/off the main radio through the wake-up receiver. That is, at least some of the UE and/or BS operations according to an embodiment may be independently performed or combined with other operations and applied.

According to an embodiment, the operation of turning on/off the main radio through the wake-up receiver after the operation of reporting the UE capability and the permission procedure of the BS may be applied to all UEs within a cell supported by the BS (e.g., RRC_CONNECTED UEs, RRC_IDLE/RRC_INACTIVE UEs, or UEs accessing the cell (e.g., RRC_CONNECTED UEs)). When the operation of reporting the UE capability and the BS permission procedure are not performed, the operation of turning on/off the main radio through the wake-up receiver may be applied to the RRC_IDLE/RRC_INACTIVE UE that camps on the cell supported by the BS. Further, various embodiments of the disclosure may include at least one of all, some, or a combination of some of the various operations of the UE including the wake-up receiver and the BS disclosed hereafter.

Hereinafter, according to various embodiments of the disclosure, the operation in which the UE having the wake-up receiver turns on and off the main radio is described. Various embodiments of the disclosure may include all, some, or a combination of some of the various operations of the UE including the wake-up receiver and the BS disclosed hereinafter. At least some of the operations of the UE and/or BS according to an embodiment may be performed independently or combined with another operation and applied.

According to an embodiment, when the main radio of the UE is on, the UE may receive a downlink signal (or data) from the BS through the main radio.

According to various embodiments of the disclosure, the on state of the main radio may be expressed that the main radio is “turned on” or the main radio is “activated”, but is not limited thereto and may be expressed as the meaning similar thereto or substantially equivalent thereto.

According to an embodiment, the activation of the main radio may mean that specific components (e.g., radio frequency (RF) or baseband (BB)) are turned on or activated, or may be defined according to the standard (e.g., 3GPP technical specification (TS) document). However, according to various embodiments of the disclosure, the disclosure is not limited to the above description, and the activation of the main radio may include a parameter having the content similar thereto or substantially equivalent thereto or performance of an operation by the parameter. Alternatively, the activation of the main radio may include performance of an operation for receiving a specific channel or signal (e.g., a SS/PBCH block including a synchronization signal or a PDCCH including a downlink control channel) defined in the 3GPP TS document by the main radio.

According to an embodiment, when the main radio of the UE is off, the UE may be in a sleep interval or may not receive a downlink signal (or data) from the BS. According to various embodiments of the disclosure, the “off state” of the main radio may be expressed that the main radio is “turned off” or the main radio is “deactivated”, but is not limited thereto and may be expressed as the meaning similar thereto or substantially equivalent thereto.

According to an embodiment, the deactivation of the main radio may mean that specific components (e.g., radio frequency (RF) or baseband (BB)) are turned off or deactivated, or may be defined according to the standard (e.g., 3GPP TS document). However, according to various embodiments of the disclosure, the disclosure is not limited to the above description, and the deactivation of the main radio may include a parameter having the content similar thereto or substantially equivalent thereto or performance of an operation by the parameter. Alternatively, the deactivation of the main radio may include that the main radio does not perform an operation for receiving a specific channel or signal (e.g., a SS/PBCH block including a synchronization signal or a PDCCH including a downlink control channel) defined in the 3GPP TS document anymore.

As described above, in order to reduce power consumption, only when the UE receives the wake-up signal (or the WUS indicating ON) from the BS, the UE triggers the main radio to be on through the wake-up receiver and allow the main radio to receive a downlink signal. When the wake-up signal is not received, the UE may turn off the main radio.

When triggering the main radio to be ON through the wake-up receiver, the UE in the RRC_CONNECTED state still measures neighboring cells in the measurement gap and may have to report the measurement value to the BS. At this time, since the UE cannot perform transmission and reception with the BS through the serving cell during the measurement gap, a problem of reducing an amount of data transmission of the UE up to a maximum of 27.5% according to a measurement gap pattern configured by the BS may occur. That is, as described above, when the measurement gap pattern is configured for the UE, even though the UE receiving the wake-up signal indicating ON switches the main radio to the ON state, not only uplink signal transmission but also downlink signal reception is not possible during the measurement gap according to the measurement gap pattern, and thus efficiency may decrease.

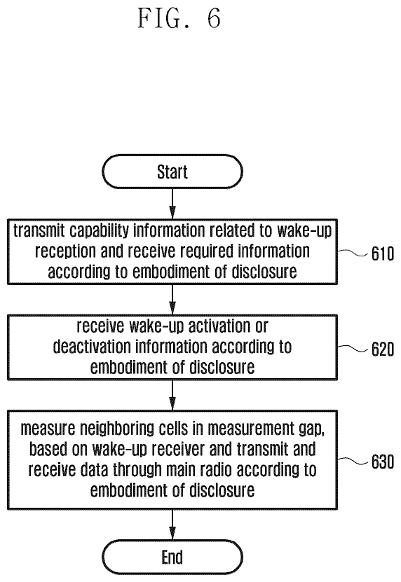

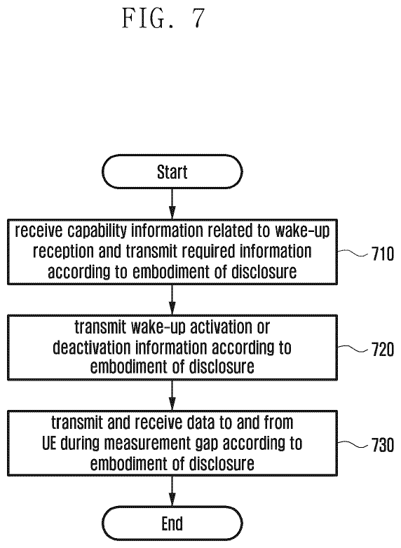

The disclosure describes a method of solving the problem. Further, the disclosure describes UE and BS procedures required for FIGS. 6 and 7. In description of the following embodiments, it may be understood that the operations or procedures performed by the main radio or the wake-up receiver for the UE including the wake-up receiver (that is, the UE having the capability for wake-up reception) are performed by the UE including the wake-up receiver (that is, the UE having the capability of wake-up reception).

For example, it is understood that reception of a signal/channel by the wake-up receiver is reception of a signal/channel by the UE (and/or the processor included in the UE) through the wake-up receiver (or by using the wake-up receiver). Further/alternatively, it may be understood that the performance of measurement by the wake-up receiver is reception of a signal/channel for the measurement through the wake-up receiver and the performance of a measurement operation based thereon by the UE (and/or the processor included in the UE).

According to an embodiment of the disclosure, it may be assumed that the main radio is in the RRC_CONNECTED state and the wake-up receiver is configured or activated to be turned on so that the wake-up signal can be detected. In the situation where the main radio is turned off and the wake-up receiver receives the wake-up signal and turns on the main radio, a detailed method by which the main radio still receives a downlink signal from the BS during the measurement gap and transmits an uplink signal to the BS and the wake-up receiver measures neighboring cells in the on state during the measurement gap instead of the main radio of the UE is described. According to an embodiment of the disclosure, even during the measurement gap, signal transmission and reception with the BS may be performed by the main radio, and the measurement operation may be performed by the wake-up receiver.

First, in the situation where the main radio is turned on, configuration information required for the case where the main radio still receives a downlink signal from the BS during the measurement gap and transmits an uplink signal to the BS and the wake-up receiver measures neighboring cells in the on state during the measurement gap instead of the main radio of the UE is described. According to an embodiment of the disclosure, even during the measurement gap, signal transmission and reception with the BS may be performed by the main radio, and the measurement operation may be performed by the wake-up receiver. According to an embodiment of the disclosure, configuration information for the operation may be provided.

[Configuration Information Required when Wake-Up Receiver Measures Neighboring Cells During Measurement Gap]

The BS may transmit a higher-layer signal making a request for information from the UE indicating whether the UE having the wake-up receiver can measure neighboring cells or cells in a specific band or a specific frequency through the wake-up receiver. Alternatively, the BS may transmit a higher-layer signal making a request for information from the UE indicating whether the measurement gap is needed when the UE having the wake-up receiver measures neighboring cells or cells in a specific band or a specific frequency through the wake-up receiver. The UE having the wake-up receiver may transmit feedback for higher-layer signals including the request to the BS through a physical signal or a higher-layer signal.

When the wake-up receiver is able to receive an on-off keying (OOK) or orthogonal frequency division multiplexing (OFDM)-based signal, configuration information indicating whether the neighboring cells or the cells in the specific band or the specific frequency support transmission of the OOK-based signal (OOK-based wake-up signal or OOK-based synchronization signal) that can be received (or measured) by the wake-up receiver and/or support transmission of the OFDM-based signal (e.g., NR synchronization signal block, PSS, SSS, or PBCH) that can be received (or measured) by the wake-up receiver may be received by the UE through a higher-layer signal.

Subsequently, in addition to cell IDs of the neighboring cells or the cells in the specific band or the specific frequency, the time or frequency location of transmission resources of signals that can be received (or measured) by the wake-up receiver and/or which metric should be measured may be received by the UE through a higher-layer signal. At least one of the measurement metric, such as the RSRP, the RSRQ, the RSSI, the SINR, and a detection rate of the wake-up signal, may be included in the higher-layer signal.

Subsequently, in the situation where the main radio is turned on, a wake-up receiver operation scheme in which the main radio still receives a downlink signal from the BS during the measurement gap and transmits an uplink signal to the BS and the wake-up receiver measures neighboring cells in the on state during the measurement gap instead of the main radio of the UE is described. According to an embodiment of the disclosure, even during the measurement gap, signal transmission and reception with the BS may be performed by the main radio, and the measurement operation may be performed by the wake-up receiver. According to an embodiment of the disclosure, the operation of the wake-up receiver may be concretized.

[Wake-Up Receiver Operation in which Wake-Up Receiver Measures Neighboring Cells During Measurement Gap]

First, the situation where the main radio is in the RRC_CONNECTED state and the wake receiver is configured or activated to be turned on so that the wake-up signal can be detected is assumed. When the main radio is turned off and the wake-up receiver receives the wake-up signal and turns on the main radio, the wake-up receiver may be off outside the measurement gap or may be still in the on state.

According to an embodiment, when the main radio is turned off and the wake-up receiver receives the wake-up signal and turns on the main radio, the wake-up receiver may maintain the on state during the measurement gap or may be turned on in advance from the off state so that the measurement operation is possible during the measurement gap.

During the measurement gap, the wake-up receiver may measure neighboring cells, based on configuration information required for the measurement of the neighboring cells, in which case reception of the wake-up signal from the serving cell may not be possible. Accordingly, although the serving BS of the serving cell transmits the wake-up signal, the wake-up receiver may not expect reception of the wake-up signal, may expect non-reception of the wake-up signal, or may not need reception of the wake-up signal.

Measurement values for the neighboring cells measured by the wake-up receiver during the measurement gap may be filtered separately or averaged separately from, or not be mixed with measurement values for neighboring cells measured by the main radio during another measurement gap since the wake-up receiver is not configured or activated.

Further, when the neighboring cells are measured by the wake-up receiver during the measurement gap, filtering or a weighted average may be performed by the following equation for measurement values to determine a cell quality. That is, a weight factor or a weight coefficient may be applied.

$$F\_n = ( 1 - a ) * F\_ ( n - 1 ) + a * M\_n \qquad Equation 2$$

In the equation, M_n denotes a measurement result value most recently received from a physical layer, F_n denotes an updated filtered measurement result value, F_(n−1) denotes a previous filtered measurement result value, and a is a value determined from a filtering coefficient (n: natural number larger than or equal to 1). The equation may be used not only for filtering for a cell quality but also for beam filtering.

A parameter for the measurement operation based on the wake-up receiver may be configured separately from a parameter for the measurement operation based on the main radio.

For example, filtering for layer 3 filtering of measurement values to determine the cell quality (Layer 3 filtering for cell quality), a coefficient value for averaging, N best beams (e.g., a value of N) exceeding an absolute threshold, the absolute threshold, or the like may be configured, through a higher-layer signal, separately from filtering, a coefficient value for averaging, a sampling rate value, N′ best beams (e.g., a value of N′) exceeding an absolute threshold, the absolute threshold, or the like used for measuring the neighboring cells by the main radio since the wake-up receiver is not configured or activated.

For example, filtering for layer 3 beam filtering, a coefficient value for averaging, N best beams (e.g., a value of N) exceeding an absolute threshold, the absolute threshold, or the like when neighboring cells are measured by the wake-up receiver during the measurement gap may be configured, through a higher-layer signal, separately from filtering, a coefficient value for averaging, a sampling rate value, N best beams (e.g., a value of N) exceeding an absolute threshold, the absolute threshold, or the like used for measuring the neighboring cells by the main radio since the wake-up receiver is not configured or activated

Subsequently, a method of reporting a measurement result value measured by the operation of the wake-up receiver is described.

### [Report on Value Measured by Wake-Up Receiver]

According to an embodiment, when the measurement result value measured by the wake-up receiver meets a specific condition, the measurement result value may be reported to the BS and periodically reported to the BS.

First, the case where the report is transmitted to the BS when the specific condition is met is described.

According to an embodiment, the measurement result value may be reported to the BS when the measurement result value is larger than a threshold A configured by the BS. The threshold A may be configured separately from a value for the main radio by a higher-layer signal from the BS so that the threshold value A can be compared with measurement values for the neighboring cells measured by the wake-up receiver during the measurement gap.

According to an embodiment, the measurement result value may be reported to the BS when the measurement result value is larger than, by an offset A, a RRM measurement result value measured for a PCell/PSCell by the wake-up receiver or the main radio. The offset A may be configured separately from a value for the main radio by a higher-layer signal from the BS so that the offset A can be applied to the measurement values for the neighboring cells measured during the measurement gap.

According to an embodiment, the measurement result value may be reported to the BS when the measurement result value is larger than, by an offset B, a RRM measurement result value measured for a SCell by the wake-up receiver or the main radio. The offset B may be configured separately from a value for the main radio by a higher-layer signal from the BS so that the offset B can be applied to the measurement values for the neighboring cells measured during the measurement gap.

According to an embodiment, the measurement result value may be reported to the BS when the RRM measurement result value measured for the PCell/PScell by the wake-up receiver or the main radio is smaller than a threshold B and the measurement result value is larger than a threshold C. The threshold B and the threshold C may be configured separately from the value for the main radio through a higher-layer from the BS so that the threshold B and the threshold C can be applied to the measurement values for the neighboring cells measured by the wake-up receiver during the measurement gap.

The UE may receive information on transmission resources and the like by a higher-layer signal from the BS so that the measurement result value can be reported to the BS when the specific condition is met. The transmission resources for reporting the measurement result value may be preconfigured by a higher-layer signal from the BS.

Subsequently, the case of periodic reporting is transmitted to the BS is described. The UE measuring the neighboring cells through the wake-up receiver during the measurement gap may receive information on a report period, a slot offset for the report, and transmission resources by a higher-layer signal from the BS so that the measurement result value measured by the wake-up receiver can be periodically reported to the BS.

Subsequently, in the situation where the main radio is turned on, the operation of the main radio in the case where the main radio still receives a downlink signal from the BS and transmits an uplink signal to the BS during the measurement gap and the wake-up receiver measures neighboring cells in the on state during the measurement gap instead of the main radio of the UE is described. According to an embodiment of the disclosure, even during the measurement gap, signal transmission and reception with the BS may be performed by the main radio, and the measurement operation may be performed by the wake-up receiver. According to an embodiment of the disclosure, the operation of the main radio may be concretized.

### [Operation of Main Radio]

According to an embodiment, the main radio may receive a downlink signal from the BS and transmit an uplink signal to the BS during the measurement gap while the wake-up receiver measures neighboring cells in the one state during the measurement gap instead of the main radio of the UE.

According to an embodiment, when the measurement result of the value measured by the wake-up receiver should be reported to the BS, the main radio may insert the measurement result into an uplink channel and transmit the uplink channel to the BS. A transmission time, frequency resources, a transmission format for uplink channel transmission (PUSCH or PUCCH, modulation scheme, coding rate (or modulation and coding scheme (MCS)), and the like), and the like may be configured by the BS separately from transmission resources and a transmission format through which the measurement result value measured by the main radio is reported to report the measurement result of the wake-up receiver during the measurement gap, and/or the transmission resources and/or the transmission format through which the measurement result value measured by the main radio is reported may be shared.

According to an embodiment, when the transmission resources and/or the transmission format through which the measurement result measured by the wake-up receiver during the measurement gap is reported is shared with the transmission resources and/or the transmission format through which the measurement result value measured by the main radio is reported, a mapping time and a mapping frequency location to map the measurement result measured by the wake-up receiver during the measurement gap to the uplink channel may be predetermined according to the standard or may be configured by the BS through a higher-layer signal. That is, when the transmission resources and/or the transmission format are shared, the resource location (time resource and/or frequency resources) to which the measurement result information by the wake-up receiver is mapped within the shared uplink channel may be configured by a higher-layer signal and/or may be predefined.

### [Location of Measurement Gap]

According to an embodiment, the time location of the measurement gap configured by a higher-layer signal may be maintained regardless of the on/off operation of the wake-up receiver or the on/off operation of the main radio, and may be determined to be valid. Accordingly, even when the main radio is turned off, the time location of the measurement gap may arrive. In this case, the wake-up receiver should monitor the wake-up signal and thus does not measure neighboring cells in the measurement gap having arrived.

According to another embodiment, the time location of the measurement gap configured by the higher-layer signal may be maintained regardless of the on/off operation of the wake-up receiver or the on/off operation of the main radio but may be determined to be valid only when the main radio is turned on. That is, in the situation where the main radio is turned off, it may be determined that the measurement gap having arrived is not valid. Accordingly, in this case, the wake-up receiver does not need to measure the neighboring cells in the measurement gap having arrived.

Hereinafter, according to various embodiments of the disclosure, a procedure of waking up the main radio when the main radio is in the sleep state is described. According to an embodiment, the operation of waking up the main radio may be combined and performed with various operations according to various embodiments of the disclosure or separately performed, and may not be a necessary component.

According to various embodiments of the disclosure, the BS may transmit a wake-up signal to the UE when there is a channel or a signal that should be transmitted to the UE. The UE or the wake-up receiver may receive the wake-up signal and turn on the main radio. According to an embodiment, the operation of receiving the wake-up signal may be an indication for waking up the main radio. According to an embodiment, the wake-up signal may include K information bits, and information of waking up the main radio may be mapped to the K information bits. For example, when the information bits including the wake-up signal is 1-bit information, “1” indicates ON and “0” may indicate OFF. On the contrary to this, “0” may indicate ON and “1” may indicate OFF.

According to an embodiment, from a viewpoint of transmission of the BS, a time point at which the wake-up signal is transmitted before the channel or the signal is transmitted may be predefined. From a viewpoint of reception of the UE, a time point at which the wake-up signal is received before the channel or the signal is received may be predefined.

According to an embodiment, the UE may transmit information on a time offset required for transmission between the wake-up signal and the channel/signal to the BS, and the BS may configure a time offset for the transmission between the wake-up signal and the channel/signal in the UE, based on the received information.

According to an embodiment, the UE may transmit information on the time offset required for transmission between the wake-up signal and the channel/signal to the BS through a UE capability information report procedure or may transmit the same to the BS through a random access preamble of the random access procedure or an uplink data channel. Of course, the disclosure is not limited thereto, and the UE may transmit information on the time offset to the BS through a higher-layer signal, through various signals, and/or a combination of various signals.

The BS may configure information on the time offset for transmission between the wake-up signal and the channel/signal in the UE through a downlink data channel of a random access response (e.g., message 2) or random access contention resolution (e.g., message 4) during the random access procedure. Of course, the disclosure is not limited thereto, and the BS may configure information on the time offset in the UE through a higher-layer signal, through various signals, and/or through a combination of various signals.

According to various embodiments of the disclosure, when there is a periodic channel or a periodic signal that the BS should transmit to the UE, the UE or the wake-up receiver may turn on the main radio according to a period based on configuration information of the periodic channel or the periodic signal configured by the BS instead of the operation for transmitting the wake-up signal whenever there is the channel or the signal that the BS should transmit.

According to an embodiment, the BS may transmit the wake-up signal only in first transmission of the periodic channel or the periodic signal and may omit transmission of the wake-up signal in repeated transmission of the channel or the signal thereafter. At this time, the UE or the wake-up receiver may turn on the main radio, based on the period according to configuration information of the periodic channel or the periodic signal configured by the BS.

According to an embodiment, types of the periodic channel or the periodic signal transmitted and received by the BS and the UE may be predefined. According to an embodiment, the types of the periodic channel or the periodic signal may be configured by the BS. For example, the BS configures the types of the periodic channel or the periodic signal in the UE through a downlink data channel of the random access response (e.g., message 2) or the random access contention resolution (e.g., message 4) or configures the same in the UE through a higher-layer signal indicating configuration information for receiving the wake-up signal or another higher-layer signal.

According to various embodiments of the disclosure, when there is a channel or a signal (e.g., a physical random access channel (PRACH), a scheduling request (SR), or a buffer status report (BSR)) which the UE should transmit to the BS or the UE should perform layer 1 (L1)/layer 3 (L3)-based measurement, the UE or the wake-up receiver may turn on the main radio regardless of the wake-up signal transmitted by the BS.

According to an embodiment, the wake-up receiver may not apply the operation of receiving the wake-up signal and turning on and off the main radio to uplink transmission that the UE transmits to the BS or L1/L3-based measurement. That is, in this case, even in the situation where the wake-up signal is not received, the wake-up signal receiver may turn on the main radio in advance or the UE (or the main radio) may be in the on state in advance, in which case the UE may not be turned on by the wake-up signal, according to the configuration of the higher-layer signal from the BS (configuration indicating whether to turn on and off the main radio by resource and transmission/reception configurations related to the uplink or L1/L3-based measurement or reception of the wake-up signal or whether to turn on and off the main radio by the uplink or L1/L3-based measurement configuration regardless of reception of the wake-up signal).

According to an embodiment, L1/L3-based measurement or the type of the uplink channel or the uplink signal of the UE transmitted regardless of the reception operation of the wake-up signal may be predefined. According to an embodiment, the type of the uplink channel or the uplink signal, or the L1/L3-based measurement may be configured by the BS. For example, the BS configures the type of the uplink channel or the uplink signal or the L1/L3-based measurement in the UE through a downlink data channel of the random access response (e.g., message 2) or random access contention resolution (e.g., message 4) or configure the same in the UE through a higher-layer signal indicating configuration information for receiving the wake-up signal or another higher-layer signal.

Hereinafter, according to various embodiments of the disclosure, an operation for turning off the main radio when the main radio is in the on state is described. According to an embodiment, the operation of waking up the main radio when the main radio is in the on state may be combined and performed with various operations according to various embodiments of the disclosure or performed separately, and may not be a necessary component.

According to various embodiments of the disclosure, the BS may transmit a sleep signal to the UE when there is no channel or signal that should be transmitted to the UE. The UE or the wake-up receiver may receive the sleep signal and turn off the main radio. According to an embodiment, the operation itself of receiving the sleep signal may be an indication of putting the main radio to sleep. According to an embodiment, the sleep signal may be configured by the sequence separated from the wake-up signal. According to an embodiment, the sleep signal may include information to which information of putting the main radio to sleep (or turning off the main radio) is mapped in the K information bits included in the wake-up signal. For example, in the case of 1-bit information, “0” indicates OFF and “1” may indicate ON. For example, in the case of 1-bit information, “1” indicates OFF and “0” indicates ON. That is, when an information bit included in a specific signal indicates OFF, the specific signal may be analyzed as a sleep signal, and when the information bit indicates ON, the specific signal may be analyzed as a wake-up signal. That is, the sleep signal/wake-up signal may be divided according to an information bit value within the same signal.

According to various embodiments of the disclosure, the main radio of the UE may be turned off when a configured condition is met. For example, a condition configured in the main radio (a condition of turning off the main radio) corresponds to the case where the main radio cannot detect or decode a downlink control channel or a specific channel or signal during a configured interval. According to an embodiment, the BS may configure configuration information (e.g., information including an interval and a specific channel or signal) through which the UE determines to turn off the main radio in the UE through a higher-layer signal indicating configuration information for receiving a wake-up signal or another higher-layer signal.

According to various embodiments of the disclosure, the main radio of the UE may be always turned off after reception of one channel or signal.

According to an embodiment, after the wake-up receiver receives the wake-up signal from the BS and thus the main radio is turned on to receive a channel or a signal, the main radio may be turned off.

According to an embodiment, a time required for turning off the main radio after the channel or the signal is completely received may be predefined.

According to an embodiment, the UE may transmit information on the time required for turning off the main radio to the BS, and the BS may configure the required time in the UE, based on the received information.

According to an embodiment, the information on the required time transmitted by the UE may be transmitted to the BS through a UE capability information report procedure.

According to an embodiment, the information on the required time transmitted by the UE may be transmitted to the BS through a random access preamble or an uplink data channel. Of course, the disclosure is not limited thereto, and the UE may transmit the information on the required time to the BS through a higher-layer signal. The BS may configure the information on the required time transmitted to the UE in the UE through a downlink data channel of a random access response (e.g., message 2) or random access contention resolution (e.g., message 4). Of course, the disclosure is not limited thereto, and the BS may configure the information on the required time in the UE through a higher-layer signal.

According to various embodiments of the disclosure, when the UE or the main radio of the UE is in the RRC_CONNECTED state, connected mode DRX (C-DRX) is configured and thus the main radio wakes up in every DRX cycle, so that the UE may perform PDCCH reception. According to an embodiment, when the UE or the main radio of the UE is in the RRC_CONNECTED state, the UE (or main radio) may be configured to receive a signal indicating whether the UE should receive a PDCCH in the next DRX cycle.

According to an embodiment, when the main radio is in the RRC_IDLE/RRC_INACTIVE state, idle mode DRX (I-DRX) is configured and the main radio wakes up in every paging cycle, so that the UE may receive a paging PDCCH. According to an embodiment, when the main radio of the UE is in the RRC_CONNECTED state, the UE (or the main radio) may be configured to receive a signal indicating whether to receive the paging PDCCH in the next paging cycle.

Hereinafter, according to various embodiments of the disclosure, when the operation of indicating ON/OFF, based on reception of the wake-up signal by the wake-up receiver and the main radio and the operation according to configurations of C-DRX or I-DRX coexist, an embodiment for a procedure of the UE operating as the wake-up receiver is described. According to an embodiment, the operation of the UE or the main radio of the UE related to the RRC CONNECTED/IDLE/INACTIVE state may be combined and performed with various operations according to various embodiments of the disclosure or separately performed, and may not be a necessary component.

According to various embodiments of the disclosure, when the UE having the wake-up receiver receives a wake-up signal and performs the operation of turning on and off the main radio of the UE, the UE may not configure C-DRX or I-DRX and perform the operation according to the configuration. In this case, the UE may turn on the main radio of the UE and receive a physical downlink control channel (PDCCH) and a physical downlink shared channel (PDSCH) defined or configured to be received in C-DRX or I-DRX only when the wake-up signal of waking up the main radio is received instead of configuring C-DRX or I-DRX and performing the operation according to the configuration.

According to an embodiment, when the UE or the main radio of the UE is in the RRC_CONNECTED state and the operation performed by the wake-up receiver is activated or configured by the BS, the UE may turn on the main radio and perform the operation related to C-DRX configured by the BS (e.g., receive a PDCCH through the main radio within drx_onDurationTimer in every DRX cycle) when the wake-up receiver receives a wake-up signal of waking up the main radio. According to an embodiment, the UE (or the main radio) may not perform the operation configured to receive a signal (e.g., DCI format 2_6 or wake-up signal) indicating to the UE whether to receive a PDCCH in the next DRX cycle.

According to an embodiment, when the UE or the main radio of the UE is in the RRC_IDLE/INACTIVE state and the operation performed by the wake-up receiver is activated or configured by the BS, the UE may turn on the main radio and perform the operation related to I-DRX configured by the BS (e.g., receive a paging PDCCH since the main radio wakes up in every paging cycle) when the wake-up receiver receives a wake-up signal of waking up the main radio. According to an embodiment, the UE (or the main radio) may not perform the operation configured to receive a signal (e.g., DCI format 2_7 or paging early indication) indicating to the UE whether to receive a paging PDCCH in the next paging cycle.

According to an embodiment, the UE may perform the operation of waking up the main radio and the operation of turning off the main radio depending on the wake-up receiver and the wake-up signal according to various embodiments of the disclosure instead of the operation according to the configuration related to C-DRX or I-DRX. When the operation performed by the wake-up receiver is deactivated by the BS, the operations related to C-DRX or I-DRX configured by the BS may be performed again. That is, the priority of the operation based on the wake-up signal corresponding to the wake-up receiver may be higher than the priority of the operation according to the DRX configuration.

According to various embodiments of the disclosure, when the operation performed by the wake-up receiver of the UE is configured or activated by the BS and the UE or the wake-up receiver receives the wake-up signal and thus the main radio is turned on, the UE may transition to the RRC_CONNECTED state or transition to the RRC_IDLE or RRC_INACTIVE state. According to an embodiment, the state to which the UE can transition may be predetermined or may be determined by a higher-layer signal for the configuration of the operation of the wake-up receiver from the BS or a separate higher-layer signal.

According to an embodiment, in one example of the case where information on the transition of the UE is predetermined, the state of the main radio may follow a state (RRC state) right before the main radio was most recently turned on and then turned off before the current time at which the main radio is turned on. According to an embodiment, in another example of the case where information on the transition of the UE is predetermined, the state of the main radio may not be influenced by whether the operation of the wake-up receiver is configured and activated. For example, the state of the main radio of the UE is determined by only a higher-layer signal indicating at least one of RRC_CONNECTED, RRC_IDLE, or RRC_INACTIVE, and the UE may determine that the state of the main radio is not changed by whether the operation of the wake-up receiver is configured and activated.

According to an embodiment, the wake-up signal may include K information bits, and information on at least one of transitions of the main radio to the RRC_CONNECTED state, the RRC_IDLE state, and the RRC_INACTIVE state may be mapped to the K information bits.

According to an embodiment, when the UE or the main radio of the UE is in RRC_CONNECTED, based on the determined state of the UE, the main radio may wake up and receive a PDCCH in every DRX cycle by C-DRX configured by the BS or the UE (or the main radio) may be configured by the BS to receive a signal indicating whether to receive the PDCCH in the next DRX cycle. According to an embodiment, when the operation of turning off the main radio according to various embodiments is performed while the UE receives the PDCCH (e.g., an interval in which the PDCCH is received), the UE may preferentially perform the procedure for turning off the main radio.

According to an embodiment, when the UE or the main radio of the UE is in RRC_IDLE/INACTIVE, the main radio may wake up and receive a paging PDCCH in every paging cycle according to I-DRX configured by the BS. The UE (or the main radio) may be configured by the BS to receive a signal indicating whether to receive the paging PDCCH in the next paging cycle. When the operation for turning off the main radio according to various embodiments is performed while the UE receives a paging PDCCH (e.g., an interval in which the paging PDCCH is received), the UE may preferentially perform the procedure for turning off the main radio.

According to various embodiments of the disclosure, the various operations of the UE (main radio or wake-up receiver) described above may be performed regardless of the order, and the entity of the operation is interchangeable with the main radio or the wake-up receiver.

FIG. 6 is a flowchart illustrating an operation of a UE having a wake-up receiver according to an embodiment of the disclosure. Various modifications can be made to the method illustrated in the flowchart of FIG. 6. For example, although illustrated as a series of steps, various steps in the drawings may overlap, are generated in parallel, may be generated in different orders, or may be generated several times. In another example, the steps may be omitted or replaced with other steps.

Referring to FIG. 6, at operation 610 according to an embodiment, the UE transmits capability information related to wake-up reception to the BS and/or receives information required for receiving the wake-up signal from the BS.

In an embodiment, the UE including the wake-up receiver may report that the UE has a capability to wake up a main radio through the wake-up receiver to the BS and/or report capability information indicating that the UE includes the wake-up receiver to the BS.

In an embodiment, the BS may transmit a signal indicating whether to use the wake-up signal and/or configuration information for receiving the wake-up signal to the UE. Further, the UE may receive a synchronization signal for dedicated for wake-up and/or the existing synchronization signal through the wake-up receiver. Through the synchronization signals, the wake-up receiver may maintain/acquire time and frequency synchronization with the BS or perform RRM measurement.

At operation 620 according to an embodiment, the UE may receive a wake-up activation signal from the BS to receive the wake-up signal through the wake-up receiver and/or receive a wake-up deactivation signal from the BS not to receive the wake-up signal through the wake-up receiver anymore.

In an embodiment, the BS may transmit a signal indicating whether to use the wake-up receiver and/or configuration information for receiving the wake-up signal to the UE. Accordingly, among the UEs receiving the signal from the BS, the UE having the wake-up receiver may turn on/off the main radio through the wake-up receiver.

In an embodiment, without reception of the activation or deactivation signal from the BS, the UE may determine whether to activate or deactivate the wake-up receiver by measuring the synchronization signal transmitted at operation 610 from the wake-up receiver. That is, according to an embodiment, without a separate wake-up activation/deactivation signal, the UE may determine whether to activate/deactivate the wake-up receiver, based on a specific signal (e.g., a synchronization signal or the like).

At operation 630 according to an embodiment, the UE may measure neighboring cells instead of the main radio of the UE through the wake-up receiver during a measurement gap. In an embodiment, in the situation where the wake-up receiver receives the wake-up signal and turns on the main radio, the main radio may still receive a downlink signal from the BS and transmit an uplink signal to the BS during the measurement gap and the wake-up receiver may measure neighboring cells during the measurement gap. Thereafter, according to an embodiment of the disclosure, the UE may report a measurement result of the neighboring cells measured by the wake-up receiver to the BS.

For more detailed description of the operation of the UE illustrated in FIG. 6, refer to the description of the embodiment made above.

FIG. 7 is a flowchart illustrating an operation of a BS according to an embodiment of the disclosure. Various modifications can be made to the method illustrated in the flowchart of FIG. 7. For example, although illustrated as a series of steps, various steps in the drawings may overlap, are generated in parallel, may be generated in different orders, or may be generated several times. In another example, the steps may be omitted or replaced with other steps.

Referring to FIG. 7, at operation 710 according to an embodiment, the BS receives capability information related to wake-up reception from the UE and/or transmits information required for receiving a wake-up signal to the UE according to an embodiment of the disclosure.

In an embodiment, the UE including the wake-up receiver may report that the UE has a capability to wake up a main radio through the wake-up receiver to the BS and/or report capability information indicating that the UE includes the wake-up receiver to the BS.

In an embodiment, the BS may transmit a signal indicating whether to use the wake-up receiver and/or configuration information for receiving the wake-up signal to the UE. Further, the BS may transmit a synchronization signal for wake-up only and/or the existing synchronization signal to the UE.

At operation 720 according to an embodiment, the BS may transmit a wake-up activation signal to the UE to receive the wake-up signal through the wake-up receiver according to an embodiment of the disclosure and/or transmit a wake-up deactivation signal not to receive the wake-up signal through the wake-up receiver anymore, based on determination indicating whether to allow the use of the wake-up receiver of the UE.

In an embodiment, the BS may transmit a signal indicating whether to use the wake-up receiver and/or configuration information for receiving the wake-up signal to the UE. Accordingly, among the UEs receiving the signal from the BS, the UE having the wake-up receiver may turn on/off the main radio through the wake-up receiver. In an embodiment, the BS may transmit a synchronization signal dedicated for the wake-up receiver, a SS/PBCH, or the wake-up signal that the UE needs to the UE.

At operation 730 according to an embodiment, the BS may transmit and receive data to and from the UE during the measurement gap configured in the UE.

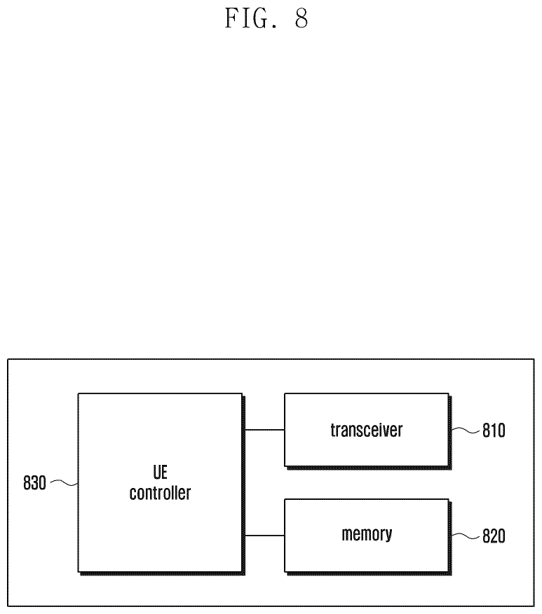

FIG. 8 illustrates a structure of a UE according to an embodiment of the disclosure.

Referring to FIG. 8, the UE of the disclosure may include a transceiver 810, memory 820, and a UE controller (or processor) 830. According to the communication method of the UE, the UE controller 830, the transceiver 810, and the memory 820 may operate. However, the components of the UE are not limited to the above example. For example, the UE includes more or fewer components than the above components. Further, the UE controller 830, the transceiver 810, and the memory 820 may be implemented in the form of a single chip.

The transceiver 810 collectively refers to a receiver of the UE and a transmitter of the UE and may transmit and receive signals to and from the BS or network entities. The signals transmitted and received to and from the BS may include control information and data. To this end, the transceiver 810 may be constituted with a radio frequency (RF) transmitter for up-converting and amplifying a frequency of a transmitted signal and an RF receiver for low-noise amplifying a received signal and down-converting the frequency. However, this is an embodiment of the transceiver 810, and components of the transceiver 810 are not limited to the RF transmitter and the RF receiver.

The transceiver 810 may include a wired/wireless transceiver and various components for transmitting and receiving a signal. The transceiver 810 may receive a signal through a radio channel, output the signal to the UE controller 830, and transmit the signal output from the UE controller 830 through the radio channel. The transceiver 810 may receive a communication signal, output the communication signal to the UE controller 830, and transmit the signal output from the UE controller 830 to the BS or network entities through a wired/wireless network.

The memory 820 may store programs and data required for the operation of the UE. The memory 820 may store control information or data included in a signal acquired by the UE. The memory 820 may be configured by a storage medium such as read only memory (ROM), random access memory (RAM), hard disc, compact disc-ROM (CD-ROM), and digital versatile disk (DVD), or a combination of the storage media.

The UE controller 830 may control a series of processes so that the UE can operate according to the embodiments of the disclosure. The UE controller 830 may include one or more processors. For example, the UE controller 830 includes a communication processor (CP) that performs a control for communication, and an application processor (AP) that controls a higher layer such as an application program.

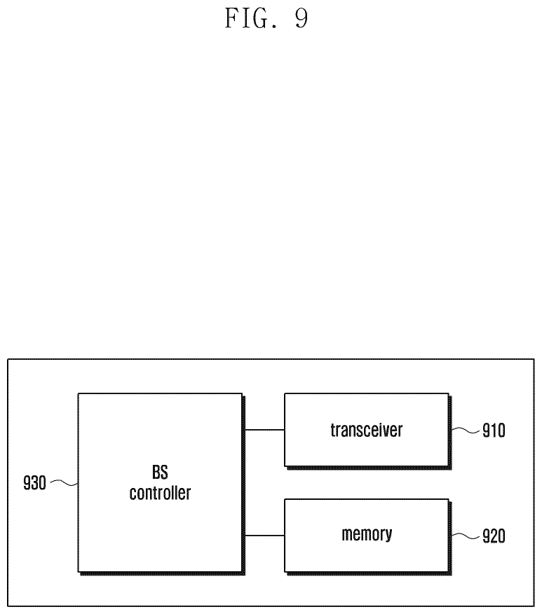

FIG. 9 illustrates a structure of a BS according to an embodiment of the disclosure.

Referring to FIG. 9, the BS of the disclosure may include a transceiver 910, memory 920, and a BS controller (or processor) 930. According to the above-described communication method of the BS, the BS controller 930, the transceiver 910, and the memory 920 can operate. However, the components of the BS are not limited to the above example. For example, the BS includes more or fewer components than the above-described components. Referring to FIG. 9, according to an embodiment, the BS of FIG. 9 may be implemented to have entire functions separated into a central unit (CU) and a data unit (DU), in which case the CU and DU may separately perform some functions of the BS. Further, the BS controller 930, the transceiver 910, and the memory 920 of FIG. 9 may be implemented in the form of a single chip.

The transceiver 910 collectively refers to a receiver of the BS and a transmitter of the BS and may transmit and receive signals to and from the UE and/or network entities. At this time, the transmitted and received signals may include control information and data. To this end, the transceiver 910 may be constituted with an RF transmitter for up-converting and amplifying a frequency of a transmitted signal and an RF receiver for low-noise amplifying a received signal and down-converting the frequency. However, this is an embodiment of the transceiver 910, and components of the transceiver 910 are not limited to the RF transmitter and the RF receiver. The transceiver 910 may include a wired/wireless transceiver and include various components for transmitting and receiving signals.

The transceiver 910 may receive a signal through a communication channel (e.g., a radio channel), output the signal to the BS controller 930, and transmit the signal output from the BS controller 930 through the communication channel. The transceiver 910 may receive a communication signal, output the communication signal to the processor, and transmit the signal output from the processor to the UE or network entities through a wired/wireless network.

The memory 920 may store programs and data required for the operation of the BS. The memory 920 may store control information or data included in signals acquired by the BS. The memory 920 may be configured by a storage medium such as ROM, RAM, hard disc, CD-ROM, and DVD, or a combination of the storage media.

The BS controller 930 may control a series of processes so that the BS can operate according to the embodiments of the disclosure. The BS controller 930 may include one or more processors.

Methods pertaining to claims or embodiments of the disclosure may be implemented by hardware, software, or a combination of hardware and software.

In the implementation of software, a computer-readable storage medium for storing one or more programs (software modules) may be provided. The one or more programs stored in the computer-readable storage medium may be configured for execution by one or more processors within the electronic device. The one or more programs may include instructions for allowing the electronic device to perform methods according to embodiments stated in the claims or specifications of the disclosure.

The programs (software modules or software) may be stored in non-volatile memories including random access memory and flash memory, read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in memory configured by a combination of some or all of the listed components. Further, the number of configured memories may be plural.

In addition, the programs may be stored in an attachable storage device which may access the electronic device through communication networks such as the Internet, an Intranet, a local area network (LAN), wireless LAN (WLAN), and a storage area network (SAN) or a combination thereof. The storage device may access the device that implements embodiments of the disclosure through an external port. Further, a separate storage device in the communication network may access the device that implements embodiments of the disclosure.

In detailed embodiments of the disclosure, components included in the disclosure are expressed as a singular or plural form according to the proposed detailed embodiment. However, the singular or plural expression is selected to be suitable for context for convenience of description, and the disclosure is not limited to a singular component or plural components. Even components expressed in the plural form may be configured as a singular, and even a component expressed in the singular form may be configured as a plural.

Although detailed embodiments are described in the detailed description of the disclosure, various modifications can be made without departing from the scope of the disclosure. For example, some or all of the embodiments are combined with some or all of one or more other embodiments, and it is apparent that the form of the combination also corresponds to the embodiment proposed in the disclosure. Therefore, the scope of the disclosure should not be defined as being limited to the embodiments, but should be defined by the appended claims and equivalents thereof.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving, via higher layer signaling, a first configuration of measurement gap and a second configuration associated with whether signal transmission that is available to be received by the UE using a wake-up receiver (WUR) of the UE is supported by a plurality of cells;
identifying the measurement gap based on the first configuration;
identifying at least one cell supporting the signal transmission among the plurality of cells based on the second configuration; and
performing, by using the WUR during the measurement gap, a measurement for the at least one cell.

2. The method of claim 1,
wherein the signal transmission includes at least one of on-off keying (OOK)-based signal transmission or orthogonal frequency division multiplexing (OFDM)-based signal transmission, and
wherein the plurality of cells includes at least one of a neighbor cell, a cell on a particular frequency band, or a cell on a particular frequency.

3. The method of claim 2,
wherein the OOK-based signal transmission includes at least one of OOK-based wake-up signal transmission or OOK-based synchronization signal transmission, and
wherein the OFDM-based signal transmission includes at least one of primary synchronization signal (PSS) transmission, secondary synchronization signal (SSS) transmission, physical broadcast channel (PBCH) transmission, or synchronization signal block (SSB) transmission.

4. The method of claim 1, further comprising:
communicating, by using a main radio (MR) of the UE during the measurement gap, at least one of a downlink signal or an uplink signal with a serving cell different from the plurality of cells,
wherein the downlink signal does not include a wake-up signal.

5. The method of claim 1, further comprising:
receiving, via the higher layer signaling, a third configuration of a first transmission resource for a measurement report for the measurement performed by using the WUR; and
transmitting the measurement report for the measurement performed by using the WUR on the first transmission resource.

6. The method of claim 5,
wherein the measurement report is transmitted by using a MR of the UE, and
wherein the first transmission resource is configured separately from a second transmission resource for a measurement report for a measurement performed by using the MR, or the second transmission resource is shared with the first transmission resource.

7. A user equipment (UE) in a communication system, the UE comprising:
a transceiver; and
a processor coupled with the transceiver and configured to:
receive, via higher layer signaling, a first configuration of measurement gap and a second configuration associated with whether signal transmission that is available to be received by the UE using a wake-up receiver (WUR) of the UE is supported by a plurality of cells,
identify the measurement gap based on the first configuration,
identify at least one cell supporting the signal transmission among the plurality of cells based on the second configuration, and
perform, by using the WUR during the measurement gap, a measurement for the at least one cell.

8. The UE of claim 7,
wherein the signal transmission includes at least one of on-off keying (OOK)-based signal transmission or orthogonal frequency division multiplexing (OFDM)-based signal transmission, and
wherein the plurality of cells includes at least one of a neighbor cell, a cell on a particular frequency band, or a cell on a particular frequency.

9. The UE of claim 8,
wherein the OOK-based signal transmission includes at least one of OOK-based wake-up signal transmission or OOK-based synchronization signal transmission, and
wherein the OFDM-based signal transmission includes at least one of primary synchronization signal (PSS) transmission, secondary synchronization signal (SSS) transmission, physical broadcast channel (PBCH) transmission, or synchronization signal block (SSB) transmission.

10. The UE of claim 7, wherein the processor is further configured to:
communicate, by using a main radio (MR) of the UE during the measurement gap, at least one of a downlink signal or an uplink signal with a serving cell different from the plurality of cells,
wherein the downlink signal does not include a wake-up signal.

11. The UE of claim 7, wherein the processor is further configured to:
receive, via the higher layer signaling, a third configuration of a first transmission resource for a measurement report for the measurement performed by using the WUR; and
transmit the measurement report for the measurement performed by using the WUR on the first transmission resource.

12. The UE of claim 11,
wherein the measurement report is transmitted by using a MR of the UE, and
wherein the first transmission resource is configured separately from a second transmission resource for a measurement report for a measurement performed by using the MR, or the second transmission resource is shared with the first transmission resource.

13. A method performed by a base station in a communication system, the method comprising:
transmitting, to a user equipment (UE) via higher layer signaling, a first configuration of measurement gap and a second configuration associated with whether signal transmission that is available to be received by the UE using a wake-up receiver (WUR) of the UE is supported by a plurality of cells; and
receiving a measurement report for a measurement for at least one cell supporting the signal transmission among the plurality of cells,
wherein the measurement is associated with the WUR and the measurement gap.

14. The method of claim 13,
wherein the signal transmission includes at least one of on-off keying (OOK)-based signal transmission or orthogonal frequency division multiplexing (OFDM)-based signal transmission,
wherein the plurality of cells includes at least one of a neighbor cell, a cell on a particular frequency band, or a cell on a particular frequency,
wherein the OOK-based signal transmission includes at least one of OOK-based wake-up signal transmission or OOK-based synchronization signal transmission, and
wherein the OFDM-based signal transmission includes at least one of primary synchronization signal (PSS) transmission, secondary synchronization signal (SSS) transmission, physical broadcast channel (PBCH) transmission, or synchronization signal block (SSB) transmission.

15. The method of claim 13, further comprising:
transmitting, via the higher layer signaling, a third configuration of a first transmission resource for the measurement report,
wherein the measurement report is received on the first transmission resource.

16. The method of claim 15,
wherein the first transmission resource is configured separately from a second transmission resource for a measurement report for a measurement associated with a main radio of the UE, or
wherein the second transmission resource is shared with the first transmission resource.

17. A base station in a communication system, the base station comprising:
a transceiver; and
a processor coupled with the transceiver and configured to:
transmit, to a user equipment (UE) via higher layer signaling, a first configuration of measurement gap and a second configuration associated with whether signal transmission that is available to be received by the UE using a wake-up receiver (WUR) of the UE is supported by a plurality of cells, and
receive a measurement report for a measurement for at least one cell supporting the signal transmission among the plurality of cells,
wherein the measurement is associated with the WUR and the measurement gap.

18. The base station of claim 17,
wherein the signal transmission includes at least one of on-off keying (OOK)-based signal transmission or orthogonal frequency division multiplexing (OFDM)-based signal transmission,
wherein the plurality of cells includes at least one of a neighbor cell, a cell on a particular frequency band, or a cell on a particular frequency,
wherein the OOK-based signal transmission includes at least one of OOK-based wake-up signal transmission or OOK-based synchronization signal transmission, and
wherein the OFDM-based signal transmission includes at least one of primary synchronization signal (PSS) transmission, secondary synchronization signal (SSS) transmission, physical broadcast channel (PBCH) transmission, or synchronization signal block (SSB) transmission.

19. The base station of claim 17, wherein the processor is further configured to:
transmit, via the higher layer signaling, a third configuration of a first transmission resource for the measurement report, and
wherein the measurement report is received on the first transmission resource.

20. The base station of claim 19,
wherein the first transmission resource is configured separately from a second transmission resource for a measurement report for a measurement associated with a main radio of the UE, or
wherein the second transmission resource is shared with the first transmission resource.
